(19) United States
(12) Patent Application Publication
(10) Pub. No.: US 2014/0254638 A1
(43) Pub. Date: Sep. 11, 2014

(54) RELAY DEVICE AND RELAY METHOD

(71) Applicant: Panasonic Corporation, Osaka (JP)

(72) Inventor: Kazuhiko MAEDA, Osaka (JP)

(73) Assignee: Panasonic Corporation, Osaka (JP)

(21) Appl. No.: 14/140,969

(22) Filed: Dec. 26, 2013

(30) Foreign Application Priority Data
Mar. 6, 2013 (JP) 2013-044802

(51) Int. Cl. H04B 3/36

(52) U.S. Cl. CPC H04B 3/36
USPC 375/211

(57) ABSTRACT

The present disclosure provides a relay device which relays data, the relay device including a storage unit to store device information of at least one receiving device connectable to the relay device; and a communication unit to transmit the device information to a transmitting device when authentication is performed between the transmitting device and the relay device, the device information being pre-stored in the storage unit before the authentication is performed.

### CROSS REFERENCE TO RELATED APPLICATION

The present application is based on and claims priority of Japanese Patent Application No. 2013-044802 filed on Mar. 6, 2013. The entire disclosure of the above-identified application, including the specification, drawings and claims is incorporated herein by reference in its entirety.

### FIELD

The present disclosure relates to a relay device which relays data.

### BACKGROUND

Japanese Unexamined Patent Application Publication No. 2010-68509 discloses high-bandwidth digital content protection (HDCP). HDCP is copyright protection technology which encrypts data to be transmitted to prevent an illegal copy, and is a scheme (standard) for protecting data.

### CITATION LIST

### Patent Literature

Japanese Unexamined Patent Application Publication No. 2010-68509

### SUMMARY

### Technical Problem

The present disclosure provides a relay device capable of reducing adverse effects which may occur in starting data relaying.

### Solution to Problem

The present disclosure provides a relay device which relays data, the relay device including: a storage unit configured to store device information of at least one receiving device which is connectable to the relay device; and a communication unit configured to transmit the device information to a transmitting device when authentication is performed between the transmitting device and the relay device, the device information being pre-stored in the storage unit before the authentication is performed.

### Advantageous Effects

The relay device in the present disclosure is capable of reducing adverse effects which may occur in starting data relaying.

### BRIEF DESCRIPTION OF DRAWINGS

These and other objects, advantages and features of the present disclosure will become apparent from the following description thereof, taken in conjunction with the accompanying drawings that illustrate a specific embodiment of the present disclosure.

FIG. 1 is a block diagram illustrating the configuration of a transmitting and receiving system in a first embodiment.

FIG. 2 is a flow chart illustrating the operation of a relay device in the first embodiment.

FIG. 3 is a block diagram illustrating the configuration of a transmitting and receiving system in a second embodiment.

FIG. 4 is a flow chart illustrating the operation of a source device in the second embodiment.

FIG. 5 is a flow chart illustrating the operation of a repeater device in the second embodiment.

FIG. 6 is a flow chart illustrating the operation of a sink device in the second embodiment.

FIG. 7 is a sequence diagram illustrating the operation of the transmitting and receiving system in the second embodiment.

FIG. 8 is a diagram illustrating an example of a GUI screen of the repeater device at the time of registration in the second embodiment.

FIG. 9 is a diagram illustrating an example of a GUI screen of the sink device at the time of registration in the second embodiment.

FIG. 10 is a diagram illustrating an example of the GUI screen of the repeater device at the time of transfer in the second embodiment.

FIG. 11 is a diagram illustrating an example of the GUI screen of the sink device at the time of transfer in the second embodiment.

FIG. 12 is a block diagram illustrating the configuration of a transmitting and receiving system in a third embodiment.

FIG. 13 is a flow chart illustrating the operation of a repeater device in the third embodiment.

FIG. 14 is a flow chart illustrating the operation of a sink device in the third embodiment.

FIG. 15 is a block diagram illustrating the configuration of a transmitting and receiving system in a first aspect of a fourth embodiment.

FIG. 16 is a sequence diagram illustrating operation of the transmitting and receiving system in the first aspect of the fourth embodiment.

FIG. 17 is a diagram illustrating the operation at the time of authentication between a relay device and a receiving device in the first aspect of the fourth embodiment.

FIG. 18 is a diagram illustrating the operation at the time of authentication between a transmitting device and the relay device in the first aspect of the fourth embodiment.

FIG. 19 is a diagram illustrating the operation after the time of authentication between the transmitting device and the relay device in the first aspect of the fourth embodiment.

FIG. 20 is a diagram illustrating the operation after the time of authentication between the relay device and the receiving device in the first aspect of the fourth embodiment.

FIG. 21 is a diagram illustrating a modification of the operation after the time of authentication between the relay device and the receiving device in the first aspect of the fourth embodiment.

FIG. 22 is a diagram illustrating the operation at the time of authentication in a second aspect of the fourth embodiment.

FIG. 23 is a diagram illustrating the operation after the time of authentication in the second aspect of the fourth embodiment.

### DESCRIPTION OF EMBODIMENTS

Hereinafter, an embodiment will be described in detail with reference to the drawings as needed. However, detailed description more than necessary may be omitted. For example, detailed description of well known facts and redundant description of substantially the same configuration may be omitted. This is for the purpose of avoiding unnecessarily redundant description in the following and facilitating the understanding by those skilled in the art.

The inventor provides the accompanying drawings and the following description for better understanding of the present disclosure by those skilled in the art, and it is not intended to limit the subject of description to the statement of claims.

### First Embodiment

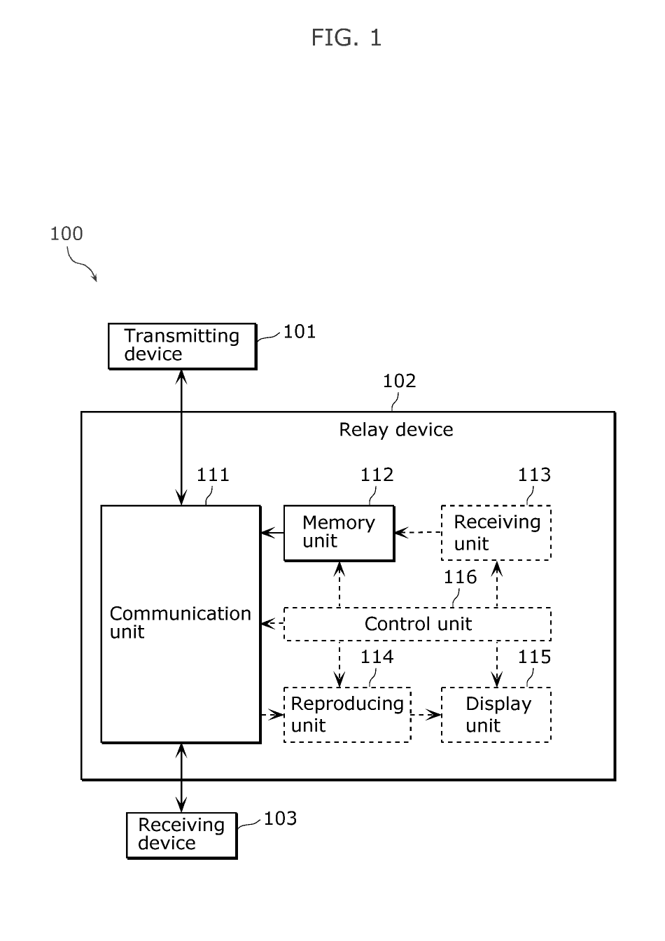

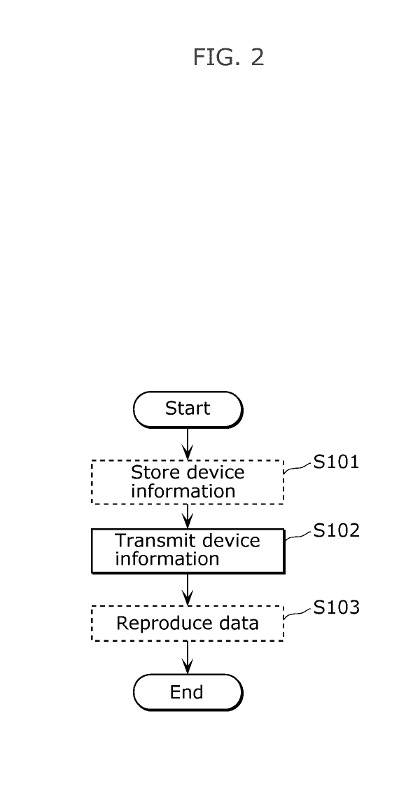

Hereafter, a first embodiment will be described with reference to FIGS. 1 and 2.

[1-1. Configuration]

FIG. 1 is a block diagram illustrating the configuration of a transmitting and receiving system in the present embodiment. As illustrated in FIG. 1, a transmitting and receiving system 100 includes a transmitting device (source device) 101, a relay device (repeater device) 102, and a receiving device (sink device) 103.

The transmitting set 101 is a device which transmits data (content). Data to be transmitted may be video data, audio data, or video data including audio data. The transmitting device 101 is a set top box which receives, for example, a broadcast signal. The transmitting device 101 may be a recorder which records video data or audio data. The transmitting device 101 may be a player such as a DVD player which reproduces the signal in a recording medium. The transmitting device 101 may be a television receiver.

The relay device 102 is a device which relays data. The relay device 102 receives data which is transmitted by the transmitting device 101. The relay device 102 then transmits the received data to the receiving device 103. The relay device 102 thereby relays the data to be transmitted from the transmitting device 101 to the receiving device 103. For example, the relay device 102 is a television receiver. Optionally, the relay device 102 may be a recorder, a player, or a set top box similarly to the transmitting device 101.

The receiving set 103 is a device which receives data. The receiving device 103 receives the data transmitted by the relay device 102. The receiving device 103 thereby can receive the data transmitted by the transmitting device 101 via the relay device 102. For example, the receiving device 103 is a smart phone. Optionally, the receiving device 103 may be a mobile phone or a mobile terminal. Similarly to the relay device 102, the receiving device 103 may be a television receiver, a recorder, a player, or a set top box.

The transmitting device 101 and the relay device 102 can be connected to each other with a wire or wirelessly. For example, the transmitting device 101 and the relay device 102 may be connected to each other wirelessly via a network such as wireless fidelity (Wi-Fi), or via a router. The relay device 102 and the receiving device 103 also can be connected to each other with a wire or wirelessly similarly to the transmitting device 101 and the relay device 102.

The relay device 102 includes a communication unit 111, a storage unit 112, a receiving unit 113, a reproducing unit 114, a display unit 115, and a control unit 116.

The communication unit 111 is an interface for communicating with an external device. For example, the communication unit 111 transmits the device information of the receiving device 103 to the transmitting device 101. The communication unit 111 may include a first communication unit to communicate with the transmitting device 101, and a second communication unit to communicate with the receiving device 103. For example, the first communication unit may receive the data transmitted from the transmitting device 101, and the second communication unit may transmit the data received by the first communication unit to the receiving device 103.

The storage unit 112 is a storage unit including a storage element such as a memory and configured to store information. For example, the storage unit 112 stores the device information of the receiving device 103 which is connectable to the relay device 102. The device information is information for identifying the receiving device 103, and may be a ReceiverID in HDCP or a key selection vector (KSV).

The receiving unit 113 is an interface to receive information. The receiving unit 113 may be included in the communication unit 111. For example, the receiving unit 113 receives the device information of the receiving device 103 from a device other than the receiving device 103.

The reproducing unit 114 is a processing unit configured to reproduce data. For example, the reproducing unit 114 reproduces the data received by the communication unit 111.

The display unit 115 is a display to display an image or a video. For example, the display unit 115 displays a graphical user interface (GUI) for storing the device information of the receiving device 103 in the storage unit 112. For example, the display unit 115 displays the data reproduced by the reproducing unit 114 as an image or a video.

The control unit 116 is a controller to control the operation of each component included in the relay device 102. For example, the control unit 116 can communicate with an external device via the communication unit 111 by causing the communication unit 111 to communicate with the external device. For example, the control unit 116 may authenticate the transmitting device 101 or the receiving device 103 via the communication unit 111. For example, the control unit 116 may store the device information of the receiving device 103 in the storage unit 112.

For example, when authentication is performed between the transmitting device 101 and the relay device 102, keys used for encryption and decryption are exchanged between the transmitting device 101 and the relay device 102. After the authentication, the transmitting device 101 encrypts data using a key and transmits the encrypted data to the relay device 102. The relay device 102 decrypts the data using a key.

For example, when authentication is performed between the relay device 102 and the receiving device 103, keys used for encryption and decryption are exchanged between the relay device 102 and the receiving device 103. After the authentication, the relay device 102 encrypts data using a key and transmits the encrypted data to the receiving device 103. The receiving set 103 decrypts the data using a key.

The authentication, the exchange of keys, and the encryption and decryption may be performed by the control unit 116 or the communication unit 111.

[1-2. Operation]

The operation of the relay device 102 of the transceiver system 100 having the above configuration will be described in the following. The relay device 102 performs operations for relaying data which is to be transmitted from the transmitting device 101 to the receiving device 103. Hereinafter, each of the operations will be described in detail.

FIG. 2 is a flow chart illustrating the operation of the relay device 102 illustrated in FIG. 1. First, the device information of the receiving device 103 is stored in the storage unit 112 (S101). For example, the control unit 116 may store the device information of the receiving device 103 in the storage unit 112 according to the operation in the GUI displayed by the display unit 115. The receiving unit 113 may receive the device information of the receiving device 103, and the receiving unit 113 or the control unit 116 may store the received device information in the storage unit 112.

In this manner, the device information of the receiving device 103 is pre-stored in the storage unit 112 before authentication is performed between the transmitting device 101 and the relay device 102. Subsequently, the communication unit 111 transmits the device information of the receiving device 103 to the transmitting device 101 when authentication is performed between the transmitting device 101 and the relay device 102 (S102). The device information transmitted at this stage is the device information pre-stored in the storage unit 112 before authentication is performed between the transmitting device 101 and the relay device 102.

Even when data transmission to the receiving device 103 is not scheduled, the relay device 102 can inform the transmitting device 101 that data may be transmitted to the receiving device 103 by transmitting the device information of the receiving device 103 to the transmitting device 101. The transmitting device 101, which originally transmits data, can recognize a receiving device 103 to which data may be transmitted.

Thus, the transmitting device 101 can properly manage data. For example, the transmitting device 101 can stop data transmission according to the device information of the receiving device 103.

After authentication is performed between the transmitting device 101 and the relay device 102, the communication unit 111 receives data from the transmitting device 101, the data being allowed to be transmitted to the receiving device 103. The reproducing unit 114 reproduces the data received by the communication unit 111 (S103).

As described above, the relay device 102 previously transmits the device information of the receiving device 103 to the transmitting device 101. Therefore, when data relay starts, the relay device 102 does not need to transmit the device information of the receiving device 103 to the transmitting device 101.

For example, in HDCP, the relay device 102 cannot transmit data from the transmitting device 101 to the receiving device 103 unless the device information of the receiving device 103 is transmitted to the transmitting device 101 at the time of authentication. When the relay device 102 has been authenticated without transmitting the device information of the receiving device 103 to the transmitting device 101, data from the transmitting device 101 can be transmitted to the receiving device 103 after the relay device 102 transmits the device information of the receiving device 103 to the transmitting device 101 and the relay device 102 is authenticated again.

When re-authentication is performed while the relay device 102 is reproducing data from the transmitting device 101, a key used for data encryption is re-generated, and the reproduction of data is interrupted in the relay device 102. In the present embodiment, because the relay device 102 has already transmitted the device information of the receiving device 103 to the transmitting device 101, re-authentication is not performed when data relay starts, the receiving device 103 being connectable to the relay device 102. Therefore, even when relaying of data to the receiving device 103 starts during the data reproduction, the reproducing unit 114 can continue to reproduce data without being interrupted.

[1-3. Effect]

As described above, in the present embodiment, the relay device 102 includes the communication unit 111 and the storage unit 112. The storage unit 112 is a unit configured to store the device information of the receiving device 103 which is connectable to the relay device 102. The communication unit 111 transmits device information to the transmitting device 101 at the time of authentication, the device information being pre-stored in the storage unit 112 before the authentication.

Thus, the relay device 102 can pre-store the device information of the receiving device 103 which is connectable to the relay device 102. The relay device 102 can transmit the pre-stored device information to the transmitting device 101 at the time of authentication. Therefore, the relay device 102 does not need to transmit the device information of the receiving device 103 when data relay starts. Consequently, re-authentication does not occur when data relay starts. For this reason, the relay device 102 can reduce adverse effects which may occur in starting data relaying.

For example, the communication unit 111 may transmit the device information of the receiving device 103 to the transmitting device 101 even when connection between the relay device 102 and the receiving device 103 is not established.

Therefore, the relay device 102 does not need to transmit the device information of a receiving device 103 after the connection is established between the relay device 102 and the receiving device 103. Thus, the relay device 102 can reduce adverse effects which may occur in starting data relaying.

For example, when device information is stored in the storage unit 112, the communication unit 111 may transmit the device information to the transmitting device 101.

Thus, the relay device 102 can transmit device information to the transmitting device 101 based on whether or not a receiving device 103 connectable to the relay device 102 is present. Therefore, the relay device 102 can transmit device information to the transmitting device 101 adaptively.

For example, the display unit 115 may display a GUI for storing device information in the storage unit 112. Thus, the device information is stored in the storage unit 112 according to an operation of the GUI. Therefore, the device information is selectively stored in the storage unit 112.

The device information may be stored in the storage unit 112, for example, when the relay device 102 is manufactured. In this manner, an environment for relay is prepared at the time of manufacture.

For example, the receiving unit 113 may receive device information from another device. The device information received by the receiving unit 113 may be stored in the storage unit 112. Appropriate device information is thereby stored in the storage unit 112 via a network or the like.

For example, device information may be information for uniquely identifying the receiving device 103. Thus, the transmitting device 101 is able to identify the receiving device 103 based on the device information. Therefore, the transmitting device 101 can properly control the transmission.

For example, the device information may be a ReceiverID or a KSV. The ReceiverID is information for uniquely identifying a receiving device such as the receiving device 103 in HDCP2.x. The KSV is information for uniquely identifying a receiving device such as the receiving device 103 in HDCP1.x. The communication unit 111 may transmit the ReceiverID or KSV of the receiving device 103 at the time of authentication in accordance with HDCP. Thus, the transmitting device 101 can properly control the transmission in accordance with HDCP.

For example, the communication unit 111 may receive data from the transmitting device 101 after the authentication. The reproducing unit 114 then may reproduce the received data. Even when relaying of data to the receiving device 103 starts during the data reproduction, the reproducing unit 114 can continue to reproduce data without being interrupted.

For example, even when transmission of the data to the receiving device 103 is not scheduled at the time authentication, the communication unit 111 may transmit the device information of the receiving device 103 to the transmitting device 101 at the time of authentication, and may receive the data which is allowed to be transmitted to the receiving device 103. In this manner, the relay device 102 can start data transmission to the receiving device 103 as needed. Thus, the relay device 102 can reduce adverse effects which may occur in starting data relaying.

For example, the communication unit 111 may transmit the device information of the receiving device 103 to the transmitting device 101 before the receiving device 103 requests data. The communication unit 111 may receive the data to be transmitted to the receiving device 103 before the receiving device 103 requests data. In this manner, the relay device 102 can transmit data to the receiving device 103 at the time of request of data from the receiving device 103 without transmitting the device information of the receiving device 103 to the transmitting device 101. Thus, the relay device 102 can reduce adverse effects which may occur when responding to a request.

For example, the communication unit 111 may include a first communication unit to communicate with the transmitting device 101, and a second communication unit to communicate with the receiving device 103. The first communication unit may have a wired communication function, and the second communication unit may have a wireless communication function. Thus, the communication unit 111 can receive data from the transmitting device 101 with a wire, and can transmit data to the receiving device 103 wirelessly, for example. Even when the transmitting device 101 only has an interface for wired communication, and the receiving device 103 only has an interface for wireless communication, the relay device 102 can relay data properly.

It is to be noted that the receiving unit 113, the reproducing unit 114, the display unit 115, and the control unit 116 that are included in the relay device 102 are each an arbitrary component. For example, when the device information of the receiving device 103 is pre-stored in the storage unit 112, the receiving unit 113 to receive the device information and the display unit 115 to display a corresponding GUI do not need to be included in the relay device 102. Each component in the relay device 102 may perform an operation independently of the control unit 116. For this reason, the control unit 116 does not need to be included in the relay device 102.

Even when the relay device 102 is relaying data from the transmitting device 101 to a receiving device other than the receiving device 103, the relay device 102 can start relaying to the receiving device 103 without interrupting the relaying to the other receiving device. Therefore, even when the reproducing unit 114 is not included in the relay device 102, the relay device 102 can reduce adverse effects which may occur in starting data relaying.

Thus, the receiving unit 113, the reproducing unit 114, the display unit 115, and the control unit 116 each do not need to be included in the relay device 102. The relay device 102 does not need to perform the operation which is to be performed by these units.

### Second Embodiment

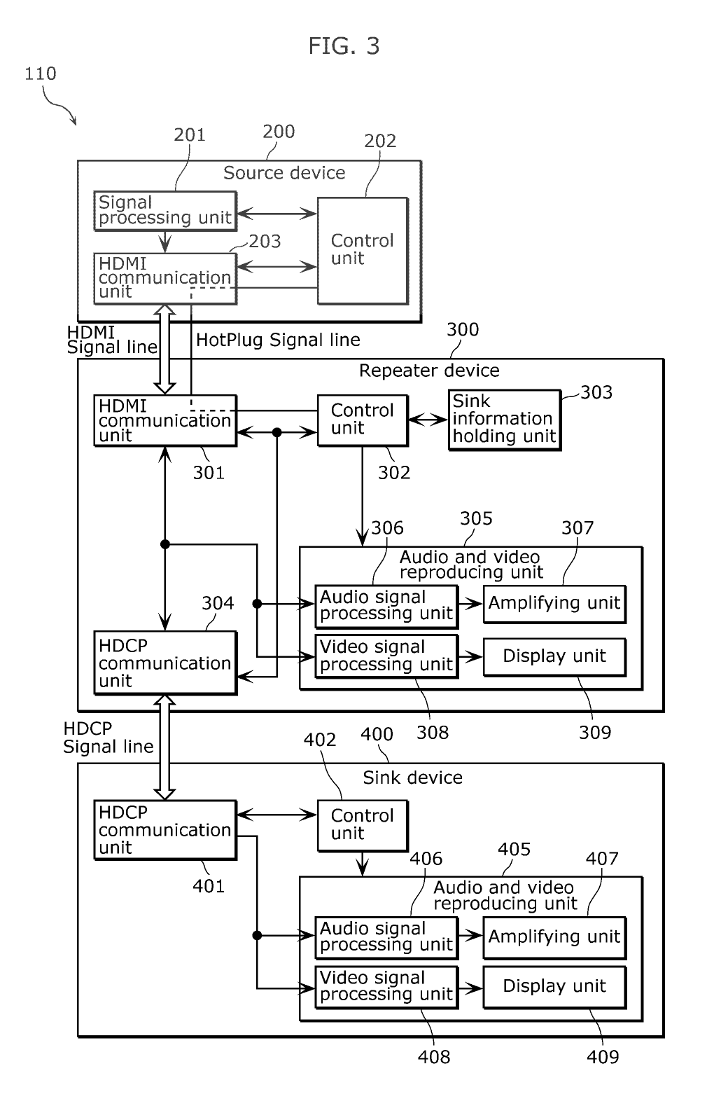

Hereinafter, a second embodiment will be described with reference to FIGS. 3 to 11. A first example of the first embodiment is described as the second embodiment.

[2-1. Configuration]

FIG. 3 is a block diagram illustrating the configuration of a transmitting and receiving system in the present embodiment. As illustrated in FIG. 3, a transmitting and receiving system 110 includes a source device 200, a repeater device 300, and a sink device 400.

The source device 200 is a transmitting device to transmit data in the transmitting and receiving system 110. For example, the source device 200 is a set top box. The source device 200 includes a signal processing unit 201, a control unit 202, and an HDMI communication unit 203.

The signal processing unit 201 is a processing unit to process signals (data). A signal to be processed may be an audio signal representing an audio, a video signal representing a video, or a video signal representing a video including an audio. For example, the signal processing unit 201 acquires a signal representing a video or an audio via a broadcast or a network.

The control unit 202 is a controller to control the operation of each component included in the source device 200. For example, the control unit 202 communicates with the repeater device 300 via the HDMI communication unit 203 by causing the HDMI communication unit 203 to communicate with the repeater device 300. The control unit 202 then authenticates the repeater device 300 via the HDMI communication unit 203. The control unit 202 encrypts data and transmits the encrypted data to the repeater device 300 in accordance with HDCP1.x.

The HDMI communication unit 203 is an interface for communicating with an external device in accordance with high-definition multimedia interface (HDMI). HDMI is a method (standard) for transmitting and receiving signals. The HDMI communication unit 203 is connected to the repeater device 300 via an HDMI signal wire. The HDMI communication unit 203 communicates with the repeater device 300 in accordance with HDMI. More specifically, the HDMI communication unit 203 communicates with the repeater device 300 in accordance with HDMI corresponding to HDCP1.x.

The source device 200 and the repeater device 300 are connected to each other via an HDMI signal wire. The HDMI signal wire includes a HotPlug signal wire. The control unit 202 of the source device 200 and a control unit 302 of the repeater device 300 detect that the source device 200 and the repeater device 300 are connected via the HDMI signal wire based on a signal which flows through the HotPlug signal wire. The control unit 202 of the source device 200 and the control unit 302 of the repeater device 300 start authentication when the connection is detected.

The repeater device 300 is a relay device to relay data in the transmitting and receiving system 110. The repeater device 300 is also a receiving device to receive data from the source device 200. For example, the repeater device 300 is a television receiver. The repeater device 300 includes an HDMI communication unit 301, the control unit 302, a sink information holding unit 303, an HDCP communication unit 304, and an audio and video reproducing unit 305.

The HDMI communication unit 301 is an interface for communicating with an external device in accordance with HDMI. The HDMI communication unit 301 is connected to the source device 200 via an HDMI signal wire. The HDMI communication unit 301 communicates with the source device 200 in accordance with HDMI. More specifically, the HDMI communication unit 301 communicates with the source device 200 in accordance with HDMI corresponding to HDCP1.x.

The control unit 302 is a controller to control the operation of each component included in the repeater device 300. For example, the control unit 302 communicates with the source device 200 via the HDMI communication unit 301 by causing the HDMI communication unit 301 to communicate with the source device 200. The control unit 302 then authenticates the source device 200 via the HDMI communication unit 301. The control unit 302 receives encrypted data from the source device 200 and decrypts the data in accordance with HDCP1.x.

For example, the control unit 302 communicates with the sink device 400 via the HDCP communication unit 304 by causing the HDCP communication unit 304 to communicate with the sink device 400. The control unit 302 authenticates the sink device 400 via the HDCP communication unit 304. The control unit 302 encrypts data and transmits the encrypted data to the sink device 400 in accordance with HDCP2.x.

The sink information holding unit 303 is a storage unit for holding sink information. Specifically, the sink information holding unit 303 includes a storage element such as a memory. The sink information is the information of the sink device 400. More specifically, the sink information is information for uniquely identifying the sink device 400, and may be a KSV in HDCP1.x or a ReceiverID in HDCP2.x. For example, the control unit 302 stores sink information in the sink information holding unit 303 based on the GUI displayed by the display unit 309.

The HDCP communication unit 304 is an interface for communicating with an external device in accordance with HDCP. The HDCP communication unit 304 is connected to the sink device 400 via an HDCP signal wire. The HDCP communication unit 304 communicates with the sink device 400 in accordance with HDCP. More specifically, the HDCP communication unit 304 communicates with the sink device 400 in accordance with HDCP2.x.

The audio and video reproducing unit 305 is a processing unit to reproduce an audio and a video. For example, the audio and video reproducing unit 305 decodes data which is received by the HDMI communication unit 301 and decrypted by the control unit 302. In this manner, the audio and video reproducing unit 305 reproduces an audio and a video. The audio and video reproducing unit 305 includes a sound signal processing unit 306, an amplifier unit 307, an image signal processing unit 308, and a display unit 309. The audio and video reproducing unit 305 may further include a loudspeaker.

The sound signal processing unit 306 is a processing unit to process audio signals. For example, the sound signal processing unit 306 decodes the audio signal included in the data decrypted by the control unit 302. The amplifier unit 307 is a processing unit to amplify an audio signal. For example, the amplifier unit 307 amplifies an audio signal decoded by the sound signal processing unit 306. The amplified audio signal is outputted as an audio via a loudspeaker.

The image signal processing unit 308 is a processing unit to process a video signal. For example, the image signal processing unit 308 decodes a video signal included in the data decrypted by the control unit 302. The display unit 309 is a display to display an image or a video. For example, the display unit 309 outputs an audio signal as an image, the audio signal being decoded by the image signal processing unit 308.

The sink device 400 is a receiving device to receive data in the transmitting and receiving system 110. For example, the sink device 400 is a smart phone. The sink device 400 includes an HDCP communication unit 401, a control unit 402, and an audio and video reproducing unit 405.

The HDCP communication unit 401 is an interface for communicating with an external device in accordance with HDCP. The HDCP communication unit 401 is connected to the repeater device 300 via an HDCP signal wire. The HDCP communication unit 401 then communicates with the repeater device 300 in accordance with HDCP. More specifically, the HDCP communication unit 401 communicates with the repeater device 300 in accordance with HDCP2.x.

The control unit 402 is a controller to control the operation of each component included in the sink device 400. For example, the control unit 402 communicates with the repeater device 300 via the to HDCP communication unit 401 by causing the HDCP communication unit 401 to communicate with the repeater device 300. The control unit 402 then authenticates the repeater device 300 via the HDCP communication unit 401. The control unit 402 receives encrypted data from the repeater device 300 and decrypts the data in accordance with HDCP2.x.

The audio and video reproducing unit 405 is a processing unit to reproduce an audio and a video. For example, the audio and video reproducing unit 405 decodes the data received by the HDCP communication unit 401 and decrypted by the control unit 402. In this manner, the audio and video reproducing unit 405 reproduces an audio and a video. The audio and video reproducing unit 405 includes a sound signal processing unit 406, an amplifier unit 407, an image signal processing unit 408, and a display unit 409. The audio and video reproducing unit 405 may further include a loudspeaker.

The sound signal processing unit 406 is a processing unit to process an audio signal. For example, the sound signal processing unit 406 decodes the audio signal included in the data decrypted by the control unit 402. The amplifier unit 407 is a processing unit to amplify an audio signal. For example, the amplifier unit 407 amplifies the audio signal decoded by the sound signal processing unit 406. The amplified audio signal is outputted as an audio via a loudspeaker.

The image signal processing unit 408 is a processing unit to process a video signal. For example, the image signal processing unit 408 decodes the video signal included in the data decrypted by the control unit 402. The display unit 409 is a display to display an image or a video. For example, the display unit 409 outputs a video signal as a video, the video signal being decoded by the image signal processing unit 408.

[2-2. Operation]

The operation of the transmitting and receiving system 110 having the above configuration will be described in the following. The transmitting and receiving system 110 performs operations for transmitting data from the source device 200 to the sink device 400. Hereinafter, each of the operations will be described in detail.

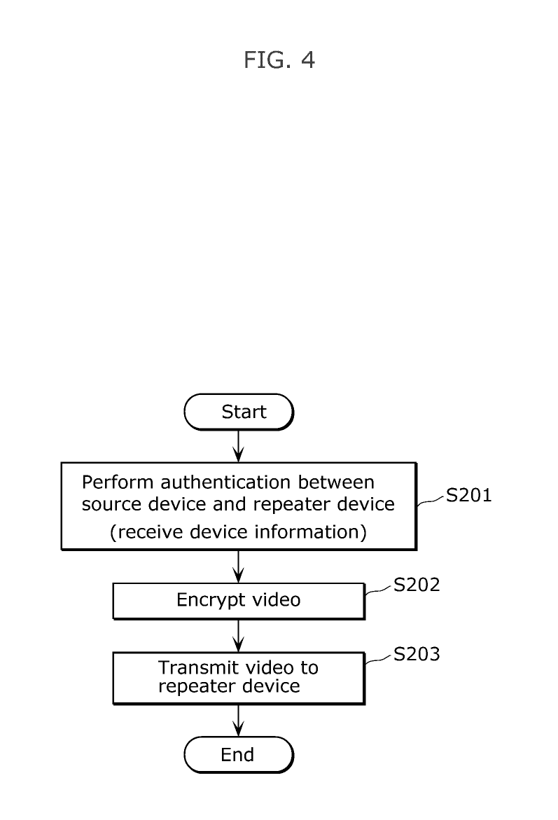

FIG. 4 is a flow chart illustrating the operation of the source device 200 shown in FIG. 3. First, authentication is performed between the source device 200 and the repeater device 300 (S201). In the above process, the control unit 202 of the source device 200 authenticates the repeater device 300. The control unit 202 first receives sink information (device information of the sink device 400) transmitted from the repeater device 300 via the HDMI communication unit 203.

After the authentication is performed successfully, the control unit 202 of the source device 200 encrypts a video (S202). The control unit 202 then transmits the encrypted video to the repeater device 300 via the HDMI communication unit 203 (S203).

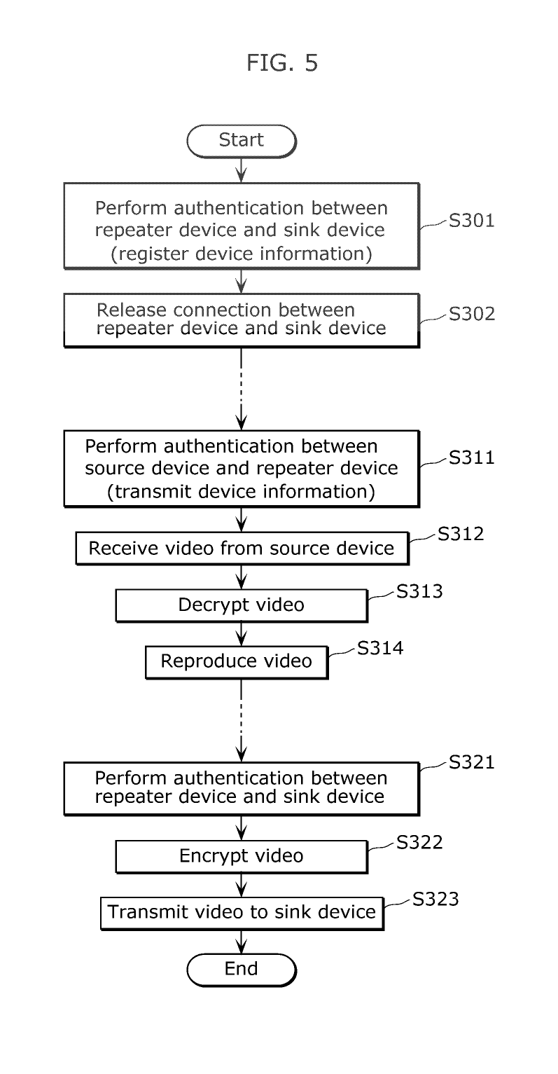

FIG. 5 is a flow chart illustrating the operation of the repeater device 300 shown in FIG. 3. First, connection is established and authentication is performed between the repeater device 300 and the sink device 400 in order to register sink information (the device information of the sink device 400) to the repeater device 300 (S301).

In the above process, the control unit 302 of the repeater device 300 authenticates the sink device 400. The control unit 302 then receives the sink information (the device information of the sink device 400) transmitted from the sink device 400 via the HDCP communication unit 304. The control unit 302 stores the sink information in the sink information holding unit 303. The sink information is thereby registered. The connection between the repeater device 300 and the sink device 400 may be released after the registration (S302).

Subsequently, authentication is performed between the source device 200 and the repeater device 300 (S311). In the above process, the control unit 302 of the repeater device 300 authenticates the source device 200. The control unit 302 first transmits the sink information stored in the sink information holding unit 303 to the source device 200 via the HDMI communication unit 301.

After the authentication is performed successfully, the control unit 302 of the repeater device 300 receives encrypted video from the source device 200 via the HDMI communication unit 301 (S312). The control unit 302 then decrypts the encrypted video (S313). The audio and video reproducing unit 305 then reproduces the video (S314).

Subsequently, the authentication is performed again between the repeater device 300 and the sink device 400 (S321). In the above process, the control unit 302 of the repeater device 300 authenticates the sink device 400. After the authentication is performed successfully, the control unit 302 of the repeater device 300 encrypts a video (S322). The control unit 302 transmits the encrypted video to the sink device 400 via the HDCP communication unit 304 (S323).

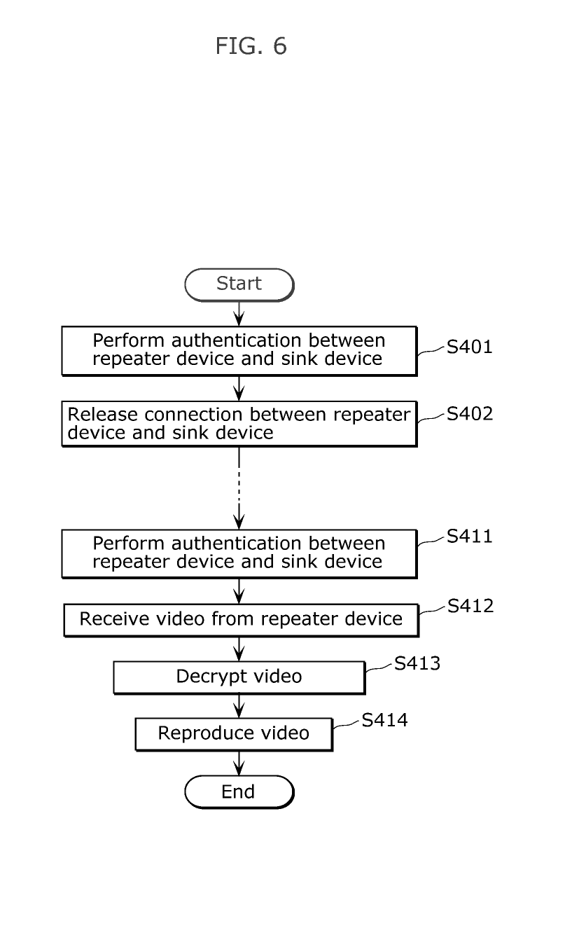

FIG. 6 is a flow chart illustrating the operation of the sink device 400 shown in FIG. 3. First, connection is established and authentication is performed between the repeater device 300 and the sink device 400 in order to register sink information (the device information of the sink device 400) to the repeater device 300 (S401).

In the above process, the control unit 402 of the sink device 400 authenticates the repeater device 300. The control unit 402 then transmits the sink information (the device information of the sink device 400) to the repeater device 300 via the HDCP communication unit 401. The sink information is thereby registered. The connection between the repeater device 300 and the sink device 400 may be released after the registration (S402).

Subsequently, authentication is performed between the repeater device 300 and the sink device 400 (S411). In the above process, the control unit 402 of the sink device 400 authenticates the repeater device 300.

After the authentication is performed successfully, the control unit 402 of the sink device 400 receives encrypted video from the repeater device 300 via the HDCP communication unit 401 (S412). The control unit 402 then decrypts the encrypted video (S413). The audio and video reproducing unit 405 reproduces the video (S414).

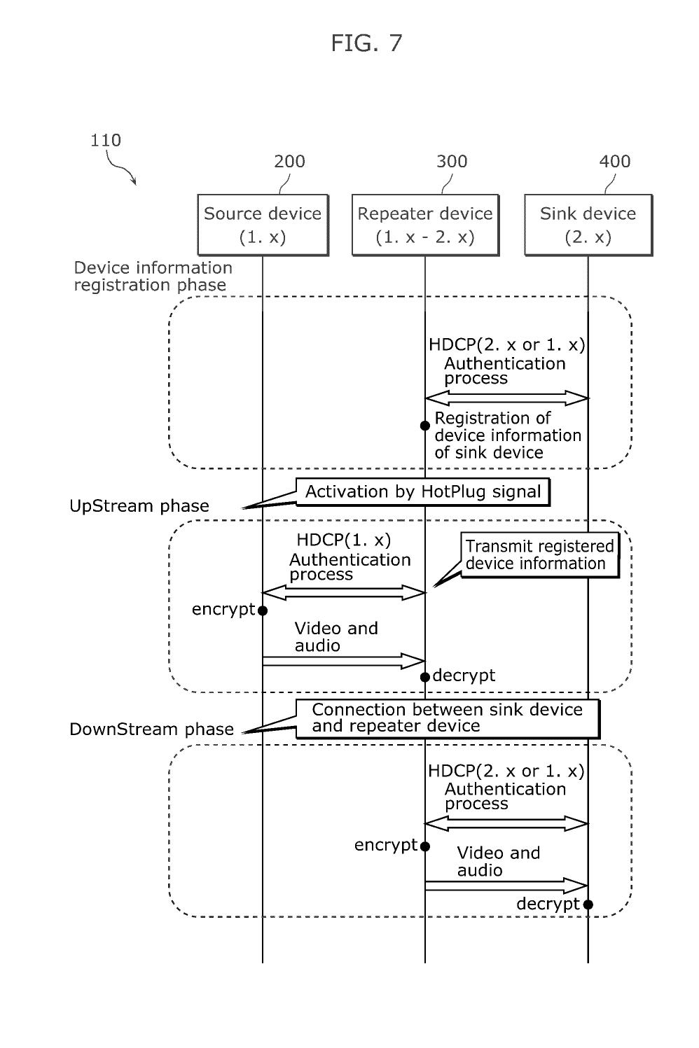

FIG. 7 is a sequence diagram illustrating the operation of the transmitting and receiving system 110 shown in FIG. 3. The source device 200 has an interface corresponding to HDCP1.x. The repeater apparatus 300 has an interface corresponding to HDCP1.x, and an interface corresponding to HDCP2.x. The sink device 400 has an interface corresponding to HDCP2.x. The operation of the transmitting and receiving system 110 is mainly divided into a device information registration phase, an UpStream phase, and a DownStream phase.

In the device information registration phase, authentication process is first performed between the repeater device 300 and the sink device 400. The authentication process is in accordance with HDCP1.x or HDCP2.x. The device information of the sink device 400 is then registered to the repeater device 300.

The UpStream phase is started by a HotPlug signal. Specifically, the source device 200 and the repeater device 300 detect connection between the source device 200 and the repeater device 300 by a HotPlug signal. The authentication process is thereby performed between the source device 200 and the repeater device 300. The authentication process is in accordance with HDCP1.x.

In the authentication process, the registered device information is transmitted from the repeater device 300 to the source device 200. In the authentication process, keys used for encryption and decryption are exchanged between the source device 200 and the repeater device 300.

After the authentication process is performed successfully, a video and an audio are encrypted in the source device 200. The encrypted video and audio are then transmitted from the source device 200 to the repeater device 300. The encrypted video and audio are decrypted in the repeater device 300.

The DownStream phase is started upon connecting the repeater device 300 and the sink device 400. First, authentication process is performed between the repeater device 300 and the sink device 400. The authentication process is in accordance with HDCP2.x or HDCP1.x. In the authentication process, keys used for encryption and decryption are exchanged between the repeater device 300 and the sink device 400.

After the authentication process is performed successfully, a video and an audio are encrypted in the repeater device 300. The encrypted video and audio are transmitted from the repeater device 300 to the sink device 400. The encrypted video and audio are decrypted in the sink device 400.

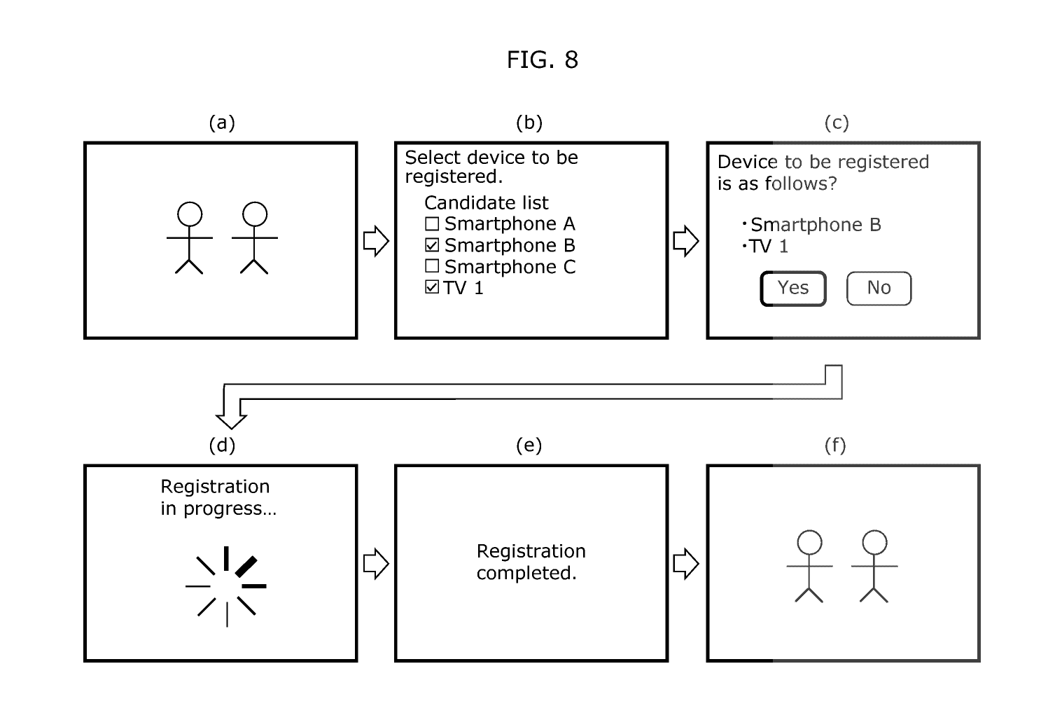

FIG. 8 is a diagram illustrating an example of GUI screen displayed by the repeater device 300 when the device information is registered. More specifically, the GUI screen illustrated in FIG. 8 is displayed on the display unit 309 of the repeater device 300.

FIG. 8 illustrates an example of GUI screen displayed by the repeater device 300 in the device information registration phase and the UpStream phase of FIG. 7. In this example, the device information is registered to the repeater device 300 by an operation of the GUI screen displayed on the display unit 309 of the repeater device 300. Smartphone A, smart phone B, smart phone C, and TV1 which are illustrated in FIG. 8 are each an example of the sink device 400.

First, when authentication is performed between the source device 200 and the repeater device 300, as illustrated in (a) of FIG. 8, the repeater device 300 is able to display a video transmitted from the source device 200.

Subsequently, an operation for registering device information is selected using a remote control device or the like of the repeater device 300, and GUI screen like (b) of FIG. 8 is thereby displayed. On the GUI screen of (b) of FIG. 8, devices connectable via Wi-Fi direct are displayed each as a candidate for a device to be registered. The repeater device 300 displays GUI screen on the entire display. Thus, even when the video is being reproduced, an interruption (break) of the reproduction is concealed.

Subsequently, a message for confirming the devices to be registered is displayed ((c) of FIG. 8). A message indicating that the registration is in progress is displayed upon an operation ((d) of FIG. 8).

While the message such as (d) of FIG. 8 is displayed, authentication is performed between the repeater device 300 and the sink device 400, and the device information of the sink device 400 is registered to the repeater device 300. At the same time authentication is performed between the source device 200 and the repeater device 300, the registered device information is transmitted to the source device 200. Then, an interruption of the reproduction occurs. The interruption is concealed by the display of (d) of FIG. 8.

After the authentication is successfully performed between the repeater device 300 and the sink device 400, and the authentication is successfully performed between the source device 200 and the repeater device 300, a message indicating completion of the registration is displayed ((e) of FIG. 8). The repeater device 300 is able to display again a video transmitted from the source device 200 as illustrated in (f) of FIG. 8.

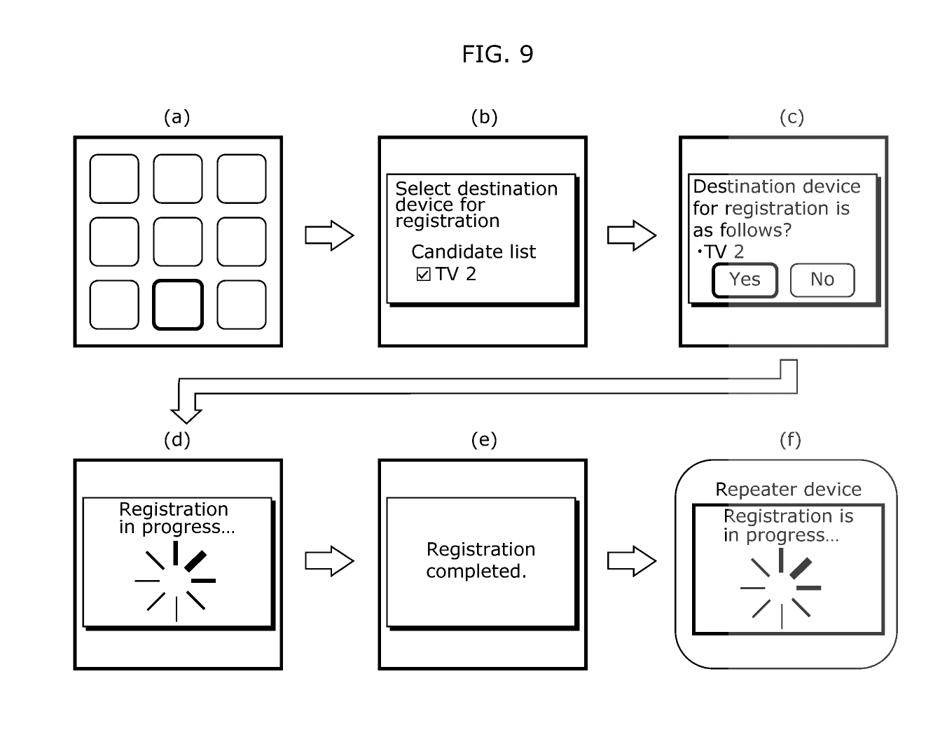

FIG. 9 is a diagram illustrating an example of GUI screen displayed by the sink device 400 when the device information is registered. More specifically, the GUI screen illustrated in FIG. 9 is displayed on the display unit 409 of the sink device 400.

FIG. 9 illustrates an example of GUI screen displayed by the sink device 400 in the device information registration phase and the UpStream phase of FIG. 7. In this example, the device information is registered into the repeater device 300 by an operation of the GUI screen displayed on the display unit 409 of the sink device 400. TV2 illustrated in FIG. 9 is an example of the repeater device 300.

First, in the initial screen ((a) of FIG. 9), an operation for device information registration is selected, and GUI screen like (b) of FIG. 9 is thereby displayed. On the GUI screen of (b) of FIG. 9, devices connectable via Wi-H direct are displayed each as a candidate for a destination device for registration. The sink device 400 does not need to display GUI screen on the entire display.

Subsequently, a message for confirming destination devices for registration are displayed ((c) of FIG. 9). A message indicating that the registration is in progress is displayed upon an operation ((d) of FIG. 9).

While the message such as (d) of FIG. 9 is displayed, authentication is performed between the repeater device 300 and the sink device 400, and the device information of the sink device 400 is registered to the repeater device 300. After the authentication is successfully performed between the repeater device 300 and the sink device 400, a message indicating completion of the registration is displayed ((e) of FIG. 9).

After the device information is registered, authentication may be performed between the source device 200 and the repeater device 300. In this case, the registered device information is transmitted to the source device 200. In this moment, when the repeater device 300 is displaying a video transmitted from the source device 200, the repeater device 300 interrupts the display of the video and displays a message that the registration is in progress ((f) of FIG. 9).

Optionally, re-authentication may be performed between the source device 200 and the repeater device 300 when the source device 200 and the repeater device 300 are re-connected. When the repeater device 300 is displaying a video transmitted from source device 200, re-authentication may be performed between the source device 200 and the repeater device 300 after the video display is terminated.

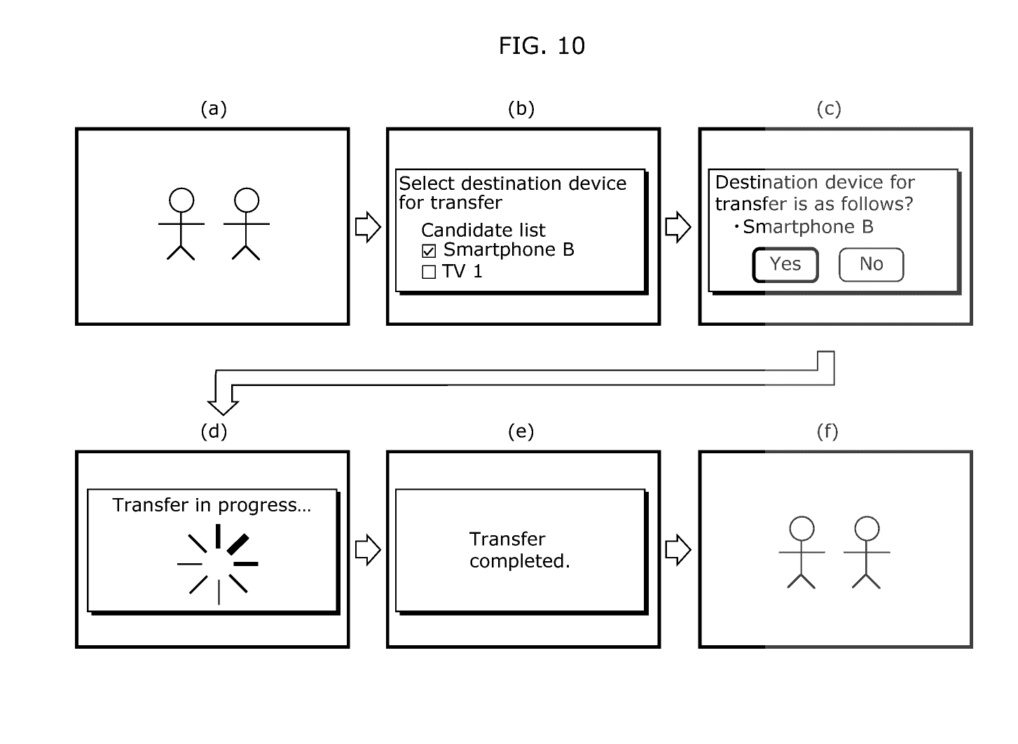

FIG. 10 is a diagram illustrating an example of GUI screen displayed by the repeater device 300 when transfer starts. More specifically, the GUI screen illustrated in FIG. 10 is displayed on the display unit 309 of the repeater device 300.

FIG. 10 illustrates an example of GUI screen displayed by the repeater device 300 in the DownStream phase of FIG. 7. In this example, a video is transmitted to the sink device 400 by an operation of the GUI screen displayed on the display unit 309 of the repeater device 300. Smart phone B and TV1 illustrated in FIG. 10 are each an example of the sink device 400.

The repeater device 300 may display a video transmitted from the source device 200 as illustrated in (a) of FIG. 10.

Subsequently, an operation for transferring a video is selected using a remote control device or the like of the repeater device 300, and GUI screen like (b) of FIG. 10 is thereby displayed. On the GUI screen of (b) of FIG. 10, only the devices which have been registered and connectable at this moment are each displayed as a candidate for a device of transfer destination. The repeater device 300 does not need to display the GUI screen on the entire display. That is, the repeater device 300 may continue to display of the video transmitted from the source device 200.

Subsequently, a message for confirming the device of transfer destination is displayed ((c) of FIG. 10). A message indicating that the transfer is in progress is displayed upon an operation ((d) of FIG. 10). During the display, authentication is performed between the repeater device 300 and the sink device 400.

After the authentication is successfully performed between the repeater device 300 and the sink device 400, a message indicating completion of the authentication process is displayed ((e) of FIG. 10). The repeater device 300 can display the video again transmitted from the source device 200 on the entire display as illustrated in (f) of FIG. 10.

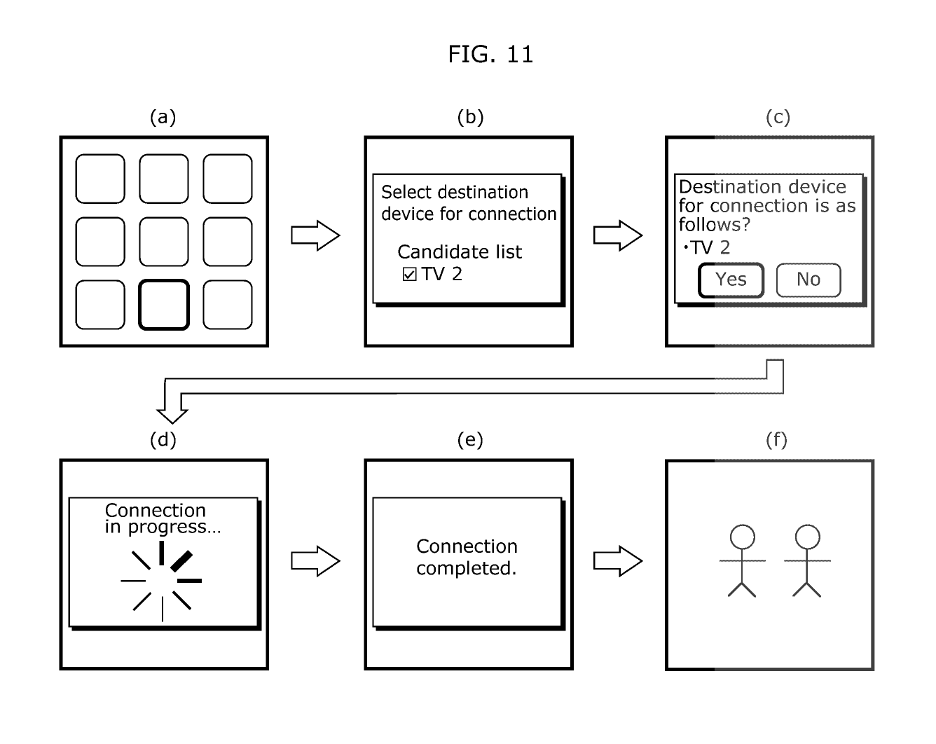

FIG. 11 is a diagram illustrating an example of GUI screen displayed by the sink device 400 when transfer starts. More specifically, the GUI screen illustrated in FIG. 11 is displayed on the display unit 409 of the sink device 400.

FIG. 11 illustrates an example of GUI screen displayed by the sink device 400 in the DownStream phase of FIG. 7. In this example, a video is transmitted to the sink device 400 by an operation of the GUI screen displayed on the display unit 409 of the sink device 400. TV2 illustrated in FIG. 11 is an example of the repeater device 300.

First, in the initial screen ((a) of FIG. 11), an operation for transferring a video is selected, and GUI screen like (b) of FIG. 11 is thereby displayed. On the GUI screen of (b) of FIG. 11, devices (repeater device 300) to which the device information of the sink device 400 is registered are each displayed as a candidate for a destination device for connection. The sink device 400 does not need to display the GUI screen on the entire display.

Subsequently, a message for confirming the device of connection destination is displayed ((c) of FIG. 11). A message indicating that the connection is in progress is displayed upon an operation ((d) of FIG. 11). During the display, authentication is performed between the repeater device 300 and the sink device 400. After the authentication is successfully performed between the repeater device 300 and the sink device 400, a message indicating completion of the authentication process is displayed ((e) of FIG. 11).

The sink device 400 then can display the video transmitted from the source device 200 via the repeater device 300 as illustrated in (f) of FIG. 11.

[2-3. Effect]

As described above, in this embodiment, before HDCP authentication (authentication in accordance with HDCP) is performed between the source device 200 and the repeater device 300, HDCP authentication is performed between the repeater device 300 and the sink device 400. After HDCP authentication is performed successfully, the repeater device 300 registers the device information of the sink device 400 (ReceiverID in HDCP2.x or KSV in HDCP1.x).

When HDCP authentication is performed between the source device 200 and the repeater device 300, the repeater device 300 transmits the registered device information to the source device 200. At this point, the repeater device 300 and the sink device 400 do not need to be connected. After the authentication is performed successfully, the repeater device 300 can reproduce the video transmitted from the source device 200.

Subsequently, HDCP authentication is performed between the repeater device 300 and the sink device 400. After HDCP authentication is performed successfully, the sink device 400 can reproduce the video transmitted from the source device 200 via the repeater device 300. In the above process, re-authentication is not performed between the source device 200 and the repeater device 300. Thus, an adverse effect of break in video reproduction can be reduced.

### Third Embodiment

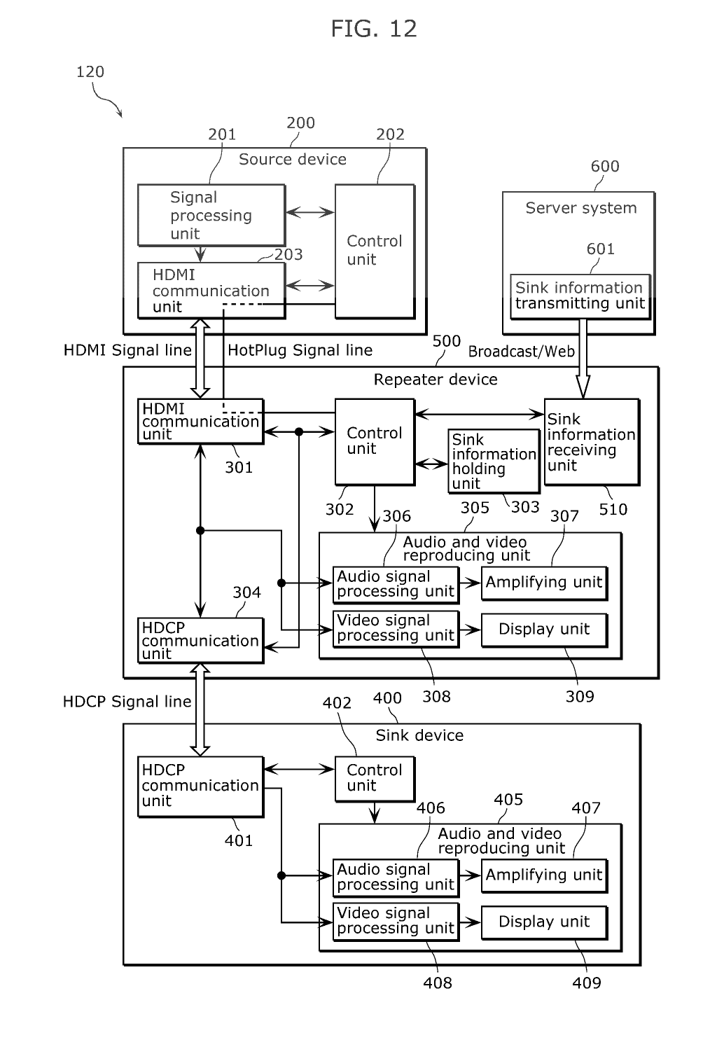

Hereinafter, a third embodiment will be described with reference to FIGS. 12 to 14. A second example of the first embodiment is described as the third embodiment.

[3-1. Configuration]

FIG. 12 is a block diagram illustrating the configuration of a transmitting and receiving system in the present embodiment. A transmitting and receiving system 120 illustrated in FIG. 12 includes a server system 600 in contrast to the transmitting and receiving system 110 illustrated in FIG. 3. The server device 600 includes a sink information transmitting unit 601. The repeater device 500 includes a sink information receiving unit 510 as an additional component.

The server device 600 provides sink information (device information of the sink device 400). More specifically, the sink information transmitting unit 601 of the server system 600 transmits the sink information to the repeater device 500 via a network such as broadcast or Web. The sink information transmitting unit 601 is an interface for transmitting information.

The sink information receiving unit 510 of the repeater device 500 is an interface for receiving information. Specifically, the sink information receiving unit 510 receives sink information from the server system 600 via a network such as broadcast or Web.

The control unit 302 of the repeater device 500 stores sink information in the sink information holding unit 303, the sink information being received by the sink information receiving unit 510. Thus, the sink information is registered without previously performing authentication between the repeater device 500 and the sink device 400. The control unit 302 may transmit sink information to the source device 200 without registering the sink information which is received by the sink information receiving unit 510.

[3-2. Operation]

The operation of the transmitting and receiving system 120 having the above configuration will be described in the following. The transmitting and receiving system 120 performs operations for transmitting data from the source device 200 to the sink device 400. Hereinafter, each of the operations will be described in detail.

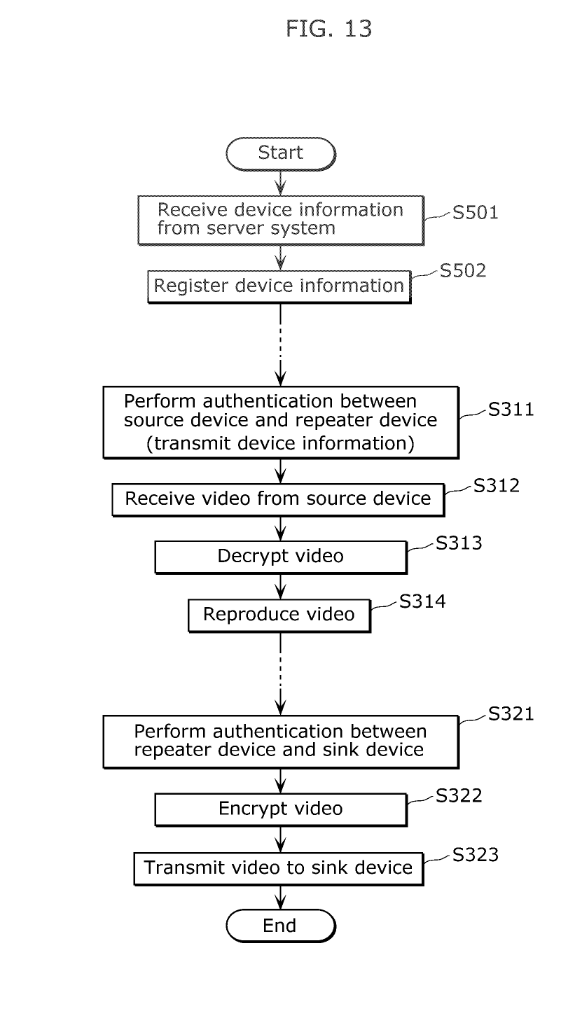

FIG. 13 is a flow chart illustrating the operation of the repeater device 500 shown in FIG. 12. First, the sink information receiving unit 510 of the repeater device 500 receives the device information of the sink device 400 from the server system 600 (S501). Subsequently, the control unit 302 stores the received device information in the sink information holding unit 303. The device information is thereby registered (S502). Subsequent operation is the same as the operation illustrated in FIG. 5.

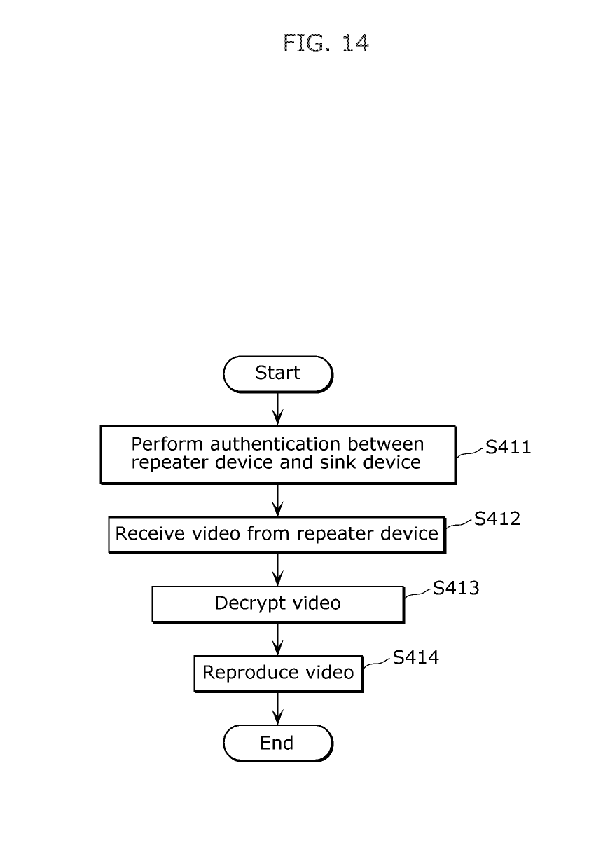

FIG. 14 is a flow chart illustrating the operation of the sink device 400 illustrated in FIG. 12. In the operation illustrated in FIG. 14, the authentication for registration of the device information (S401) and the subsequent release of connection (S402) are omitted in contrast to the operation illustrated in FIG. 6. Other operations illustrated in FIG. 14 are the same as the operations illustrated in FIG. 6.

That is, in the repeater device 500 and the sink device 400, the authentication for registration of device information (S301, S401) and the subsequent release of connection (S302, S402) are omitted. Instead of performing these steps, the repeater device 500 registers the device information which has been received from the server system 600. The operation of the source device 200 in the transmitting and receiving system 120 is the same as the operation illustrated in FIG. 4.

[3-3. Effect]

As described above, in the present embodiment, the sink information receiving unit 510 of the repeater device 500 receives the device information of the sink device 400 from the server system 600. The control unit 302 then stores the received device information in the sink information holding unit 303.

Thus, authentication for registration of the device information is omitted in the repeater device 500 and the sink device 400. Therefore, the preparatory work is reduced.

### Fourth Embodiment

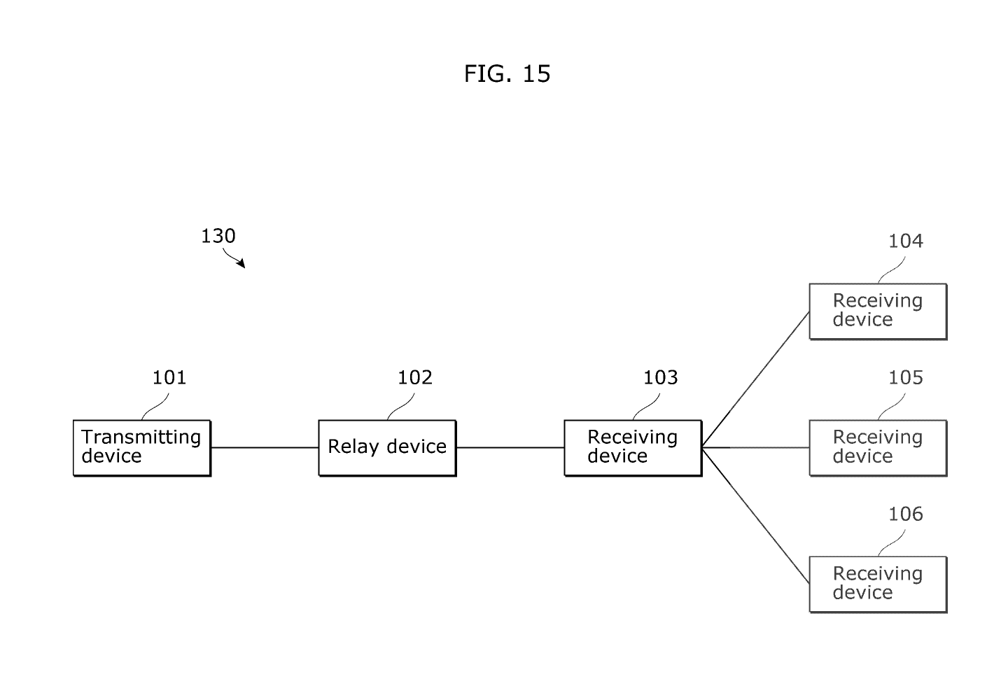

Hereinafter, a fourth embodiment will be described with reference to FIGS. 15 to 23. In the present embodiment, hierarchical information for cascade connection in addition to the device information is transmitted at the time of authentication.

[4-1. Configuration]

FIG. 15 is a block diagram illustrating the configuration of a transmitting and receiving system in a first aspect of the present embodiment. A transmitting and receiving system 130 illustrated in FIG. 15 includes the transmitting device (source device) 101, the relay device (repeater device) 102, and receiving devices (sink device) 103 to 106. That is, the transmitting and receiving system 130 illustrated in FIG. 15 includes receiving devices 104 to 106 in addition to the transmitting device 101, the relay device 102, and the receiving device 103 of the transmitting and receiving system 100 illustrated in FIG. 1.

The relay device 102 is connected to the transmitting device 101, and the receiving device 103 is connected to the relay device 102. The receiving devices 104 to 106 are connected to the receiving device 103. That is, the receiving devices 103 to 106 are hierarchically connected to the relay device 102. The hierarchical connection is also referred to as cascade connection.

Similarly to the first embodiment, the transmitting device 101 is a device which transmits data (content), and the relay device 102 is a device which relays data. The relay device 102 has the configuration illustrated in FIG. 1.

The receiving device 103 is a receiving device (sink device) which receives data and is also a relay device (repeater device) which relays data. The receiving device 103 receives data from the relay device 102. The receiving device 103 transmits the received data to the receiving devices 104 to 106. Thus, the receiving device 103 along with the relay device 102 relays the data transmitted from the transmitting device 101 to the receiving devices 104 to 106.

The receiving devices 104 to 106 are each a device which receives data. The receiving devices 104 to 106 each receives data transmitted from the receiving device 103. Thus, the receiving devices 104 to 106 can receive the data transmitted from the transmitting device 101 via the relay device 102 and the receiving device 103.

For example, similarly to the receiving device 103, the receiving devices 104 to 106 each may be a smart phone, a mobile phone, or a mobile terminal, or similarly to the relay device 102, the receiving devices 104 to 106 each may be a television receiver, a recorder, a player, or a set top box. The receiving device 103 and each of the receiving devices 104 to 106 can be connected to each other via a wire or wirelessly.

For example, the receiving device 103 and each of the receiving devices 104 to 106 may be connected to each other wirelessly via a network such as wireless fidelity Wi-Fi (Wireless Fidelity), or via a router.

The configuration illustrated in FIG. 15 is an example, and the configuration of the transmitting and receiving system 130 is not limited to the example of FIG. 15. For example, all the receiving devices 103 to 106 may be directly connected to the relay device 102, and all the receiving devices 103 to 106 may be connected in series.

[4-2. Operation]

The operation of the transmitting and receiving system 130 having the above configuration will be described in the following. The transmitting and receiving system 130 performs operations for transmitting data from the transmitting device 101 to the receiving devices 103 to 106. Hereinafter, each of the operations will be described in detail.

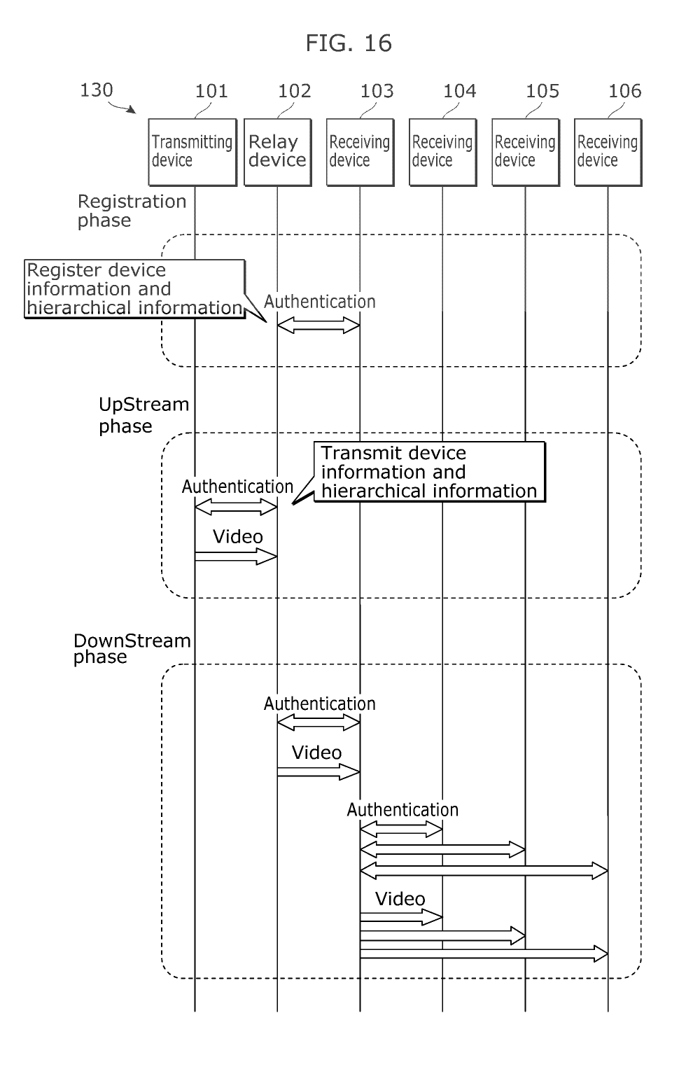

FIG. 16 is a sequence diagram illustrating the operation of transmitting and receiving system 130 illustrated in FIG. 15. The operation of transmitting and receiving system 130 is mainly divided into a registration phase, UpStream phase, and DownStream phase. The registration phase, the UpStream phase, and the DownStream phase illustrated in FIG. 16 correspond to the device information registration phase, the UpStream phase, and the DownStream phase illustrated in FIG. 7, respectively.

In the registration phase, authentication process is performed between the relay device 102 and the receiving device 103. When authentication process is performed successfully, the device information and the hierarchical information of the receiving devices 103 to 106 are registered in the relay device 102.

For example, in the authentication process, the receiving device 103 transmits the device information and the hierarchical information of the receiving devices 103 to 106, which include the receiving devices 104 to 106 currently connected to the receiving device 103, to the relay device 102. The receiving device 103 may transmit the pre-stored device information and hierarchical information of the receiving devices 103 to 106 to the relay device 102. Optionally, the receiving device 103 may transmit the device information and the hierarchical information of the receiving devices 103 to 106 to the relay device 102, the information being identified according to a command based on a registered interface of GUI.

The communication unit 111 of the relay device 102 receives the device information and the hierarchical information of the receiving devices 103 to 106. The communication unit 111 of the relay device 102 then stores the device information and the hierarchical information of the receiving devices 103 to 106 in the storage unit 112.

The communication unit 111 of the relay device 102 may store in the storage unit 112 the device information and the hierarchical information of constituent devices including the relay device 102 and the receiving devices 103 to 106, the device information and the hierarchical information being obtained by combining the information of the relay device 102 and the device information and the hierarchical information of the receiving devices 103 to 106. Instead of the communication unit 111, the control unit 116 of the relay device 102 may store the device information and the hierarchical information in the storage unit 112.

The device information is information for uniquely identifying each of the relay device 102 and the receiving devices 103 to 106, and may be a ReceiverID or a KSV in HDCP.

The hierarchical information is information which indicates the hierarchical structure of the configuration including the relay device 102 and the receiving device 103 to 106. For example, the hierarchical information is information for cascade connection and for determining whether or not relay is permitted in HDCP. Specifically, the hierarchical information may be information which indicates a hierarchical depth. In addition, the hierarchical information may indicate the number of devices. The hierarchical information may be information which indicates a more detailed hierarchical structure.

In the example of FIG. 15, the number of devices of the receiving devices 103 to 106 is four, and the hierarchical depth is two. The number of constituent devices including the relay device 102 and the receiving devices 103 to 106 is five, and the hierarchical depth is three. Such hierarchical information indicating the number of devices and the hierarchical depth is stored along with the device information in the storage unit 112.

Subsequently, in UpStream phase (upper phase), authentication process in accordance with HDCP is performed between the transmitting device 101 and the relay device 102. In the authentication process, the device information and the hierarchical information are transmitted to the transmitting device 101 from the relay device 102. Specifically, in the authentication process between the transmitting device 101 and the relay device 102, the communication unit 111 of the relay device 102 transmits the device information and hierarchical information of constituent devices to the transmitting device 101, the constituent devices including the relay device 102 and the receiving devices 103 to 106.

When the device information and the hierarchical information, which are stored in the storage unit 112, are the device information and the hierarchical information of the receiving devices 103 to 106 not including the relay device 102, the communication unit 111 combines the stored device information and hierarchical information with the information of the relay device 102. In this manner, the communication unit 111 generates the device information and the hierarchical information of the constituent devices including the relay device 102 and the receiving devices 103 to 106. The communication unit 111 then transmits the generated device information and hierarchical information to the transmitting device 101.

When the device information and the hierarchical information, which are stored in the storage unit 112, are the device information and the hierarchical information of the constituent devices including the relay device 102, the communication unit 111 transmits the device information and the hierarchical information stored in the storage unit 112 to the transmitting device 101.

In HDCP, cascade connection can be performed within a range of the number of devices and the hierarchical depth which have been permitted by the authentication process. On the other hand, re-authentication process is required for performing cascade connection beyond a range of the number of devices and the hierarchical depth which have been permitted by the authentication process.

The communication unit 111 of the relay device 102 then transmits the device information and the hierarchical information to the transmitting device 101 based on the information stored in the storage unit 112 irrespective of the current connection state between the relay device 102 and the receiving devices 103 to 106. That is, even when connection between the relay device 102 and the receiving device 103 is released after the authentication process is performed between the relay device 102 and the receiving device 103, the communication unit 111 transmits the device information and the hierarchical information to the transmitting device 101 based on the information stored in the storage unit 112.

Therefore, when the receiving devices 103 to 106 are hierarchically connected to the relay device 102, the relay device 102 can omit re-authentication process between the transmitting device 101 and the relay devices 102. Thus, an adverse effect of break in video reproduction in the relay device 102 can be reduced.

Similarly to the first embodiment, in the authentication process between the transmitting device 101 and the relay device 102, keys used for encryption and decryption are exchanged between the transmitting device 101 and the relay devices 102. After the authentication process is performed successfully, video and audio are encrypted in the transmitting device 101. The encrypted image and the encrypted audio are transmitted from the transmitting device 101 to the relay device 102. The encrypted video and the encrypted audio are then decrypted in the relay device 102.

When the authentication process is not performed successfully, the video and audio are not transmitted. For example, when the number of the constituent devices exceeds a predetermined number of devices, or when the hierarchical depth of the constituent devices exceeds a predetermined hierarchical depth, transmission of video and audio may not be appropriate. Consequently, when the number of devices and hierarchical depth, which are indicated by the hierarchical information, are out of a predetermined range, authentication process fails and terminates abnormally.

Subsequently, an authentication process is performed between the relay device 102 and the receiving device 103 in DownStream phase. In the authentication process, keys used for encryption and decryption are exchanged between the relay device 102 and the receiving device 103.

After the authentication process is performed successfully between the relay device 102 and the receiving device 103, video and audio are encrypted in the relay device 102. The encrypted video and the encrypted audio are then transmitted from the relay device 102 to the receiving device 103. The encrypted video and the encrypted audio are decrypted in the receiving device 103.

Subsequently, an authentication process is performed between the receiving device 103 and each of the receiving devices 104 to 106. In the authentication process, keys used for encryption and decryption are exchanged between the receiving device 103 and each of the receiving devices 104 to 106.

After the authentication process is performed successfully between the receiving device 103 and the receiving devices 104 to 106, the video and audio are encrypted in the receiving device 103. The encrypted video and the encrypted audio are then transmitted from the receiving device 103 to the receiving devices 104 to 106. The encrypted video and the encrypted audio are decrypted in the receiving devices 104 to 106.

As described above, in the authentication process between the transmitting device 101 and the relay device 102, the hierarchical information indicating the number of devices and the hierarchical depth of the constituent devices including the receiving devices 103 to 106 is already transmitted from the relay device 102 to the transmitting device 101. Consequently, when the receiving devices 103 to 106 are hierarchically connected to the relay device 102, re-authentication process does not occur between the transmitting device 101 and the relay device 102.

The operation illustrated in FIG. 16 is an example. Particularly, the order of the authentication process and the data transmission process between the receiving device 103 and the receiving devices 104 to 106 may be changed. For example, the authentication process and the data transmission process between the receiving device 103 and the receiving device 105 may be performed after the authentication process and the data transmission process between the receiving device 103 and the receiving device 104.

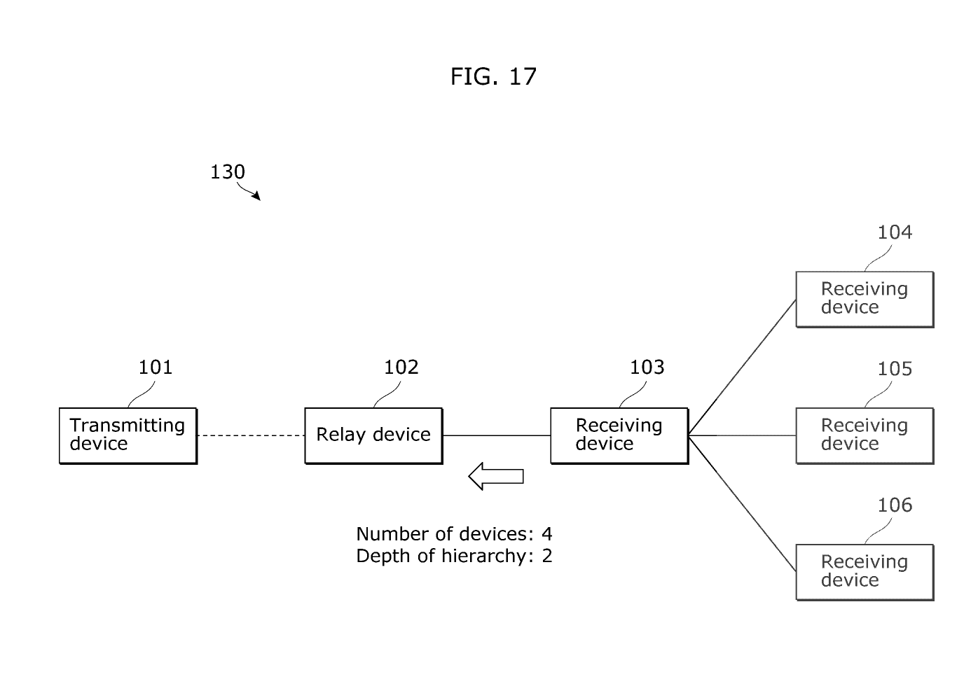

Next, the operations performed by the transmitting and receiving system 130 illustrated in FIGS. 15 and 16 with reference to FIGS. 17 to 20 will be described in the order of performance.

FIG. 17 illustrates the operation at the time of authentication between the relay device 102 and the receiving device 103. At the time of authentication between the relay device 102 and the receiving device 103, the receiving device 103 transmits the hierarchical information of the receiving devices 103 to 106 to the relay device 102. In the example of FIG. 17, the hierarchical information transmitted by the receiving device 103 indicates that the number of devices is four and the hierarchical depth is two. The communication unit 111 of the relay device 102 receives the hierarchical information transmitted by the receiving device 103.

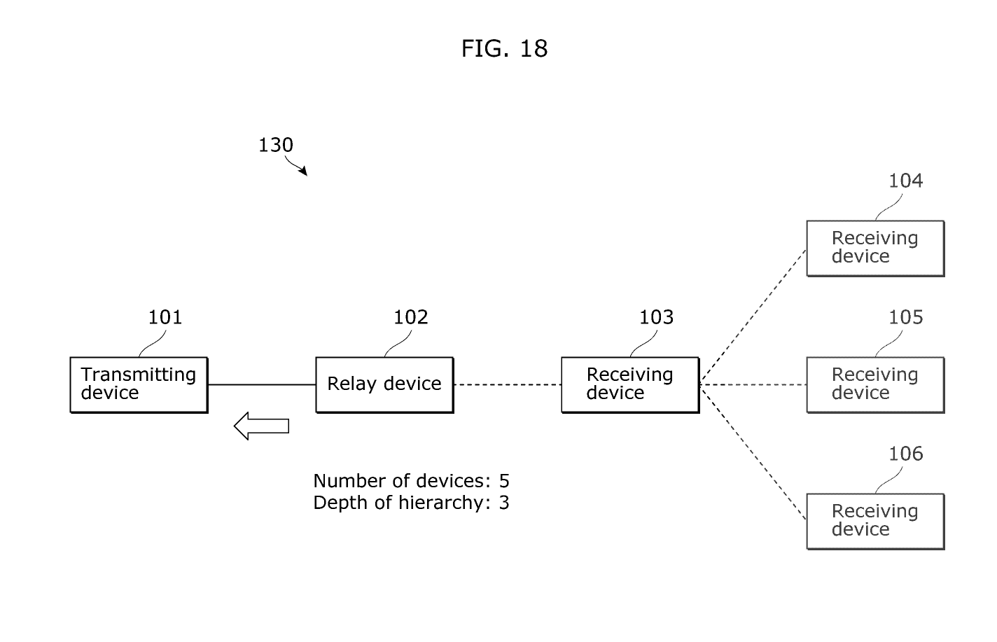

FIG. 18 is a diagram illustrating an operation after the operation illustrated in FIG. 17, and specifically illustrates the operation subsequent to the authentication between the transmitting device 101 and the relay device 102.

At the time of authentication between the transmitting device 101 and the relay device 102, the communication unit 111 of the relay device 102 transmits the hierarchical information of the constituent devices including the relay device 102 and the receiving devices 103 to 106 to the transmitting device 101. In the example of FIG. 18, the hierarchical information transmitted by the communication unit 111 indicates that the number of devices is five and the hierarchical depth is three. In this manner, the hierarchical information transmitted from the relay device 102 is combined with the information of the relay device 102.

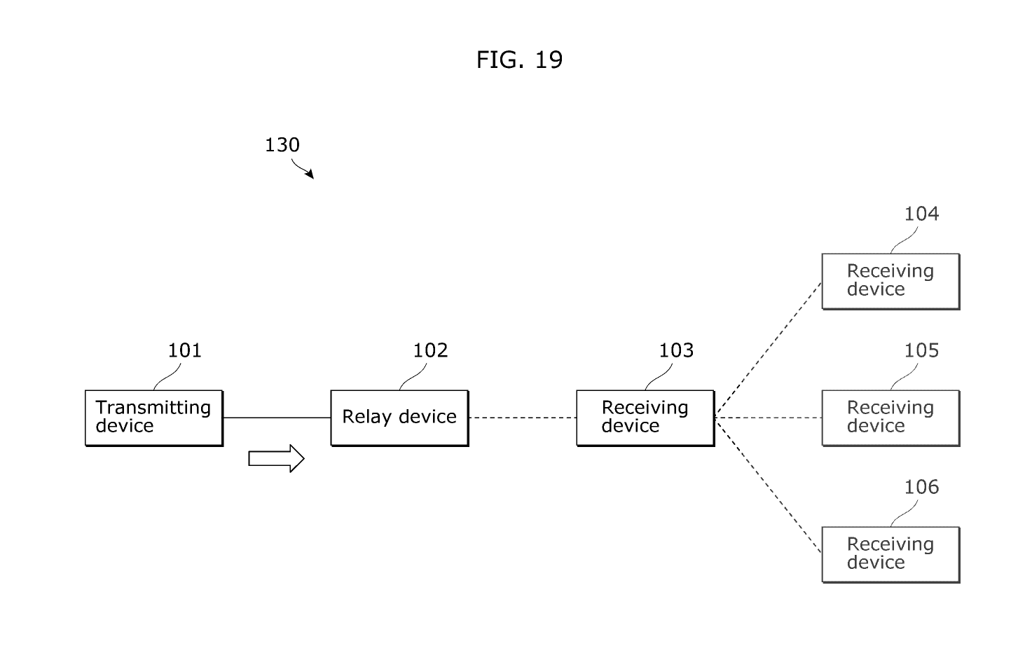

FIG. 19 is a diagram illustrating an operation after the operation illustrated in FIG. 18, and specifically illustrates the operation subsequent to the authentication between the transmitting device 101 and the relay device 102. After the authentication between the transmitting device 101 and the relay device 102, the transmitting device 101 transmits the video to the relay device 102.

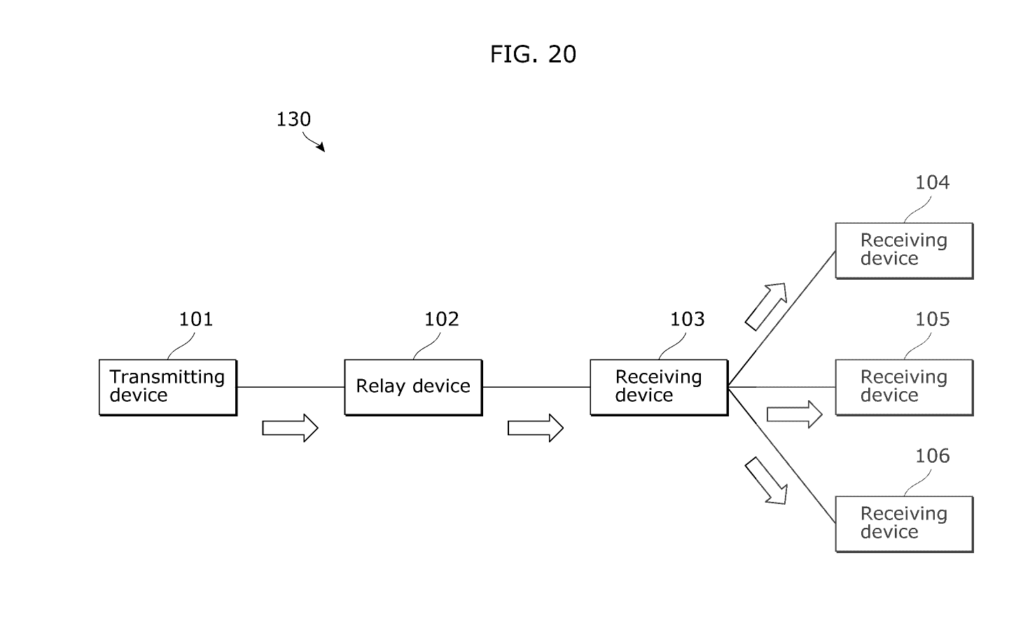

FIG. 20 is a diagram illustrating an operation after the operation illustrated in FIG. 19, and specifically illustrates the operation subsequent to the authentication between the relay device 102 and the receiving device 103. After the authentication between the relay device 102 and the receiving device 103, the communication unit 111 of the relay device 102 transmits the video to the receiving device 103. After authentication is performed between the receiving device 103 and the receiving devices 104 to 106, the receiving device 103 transmits the video to the receiving devices 104 to 106.

In this manner, even when authentication is performed between the relay device 102 and the receiving device 103, and between the receiving device 103 and the receiving devices 104 to 106 after the authentication between the transmitting device 101 and the relay device 102, re-authentication does not occur between the transmitting device 101 and the relay device 102.

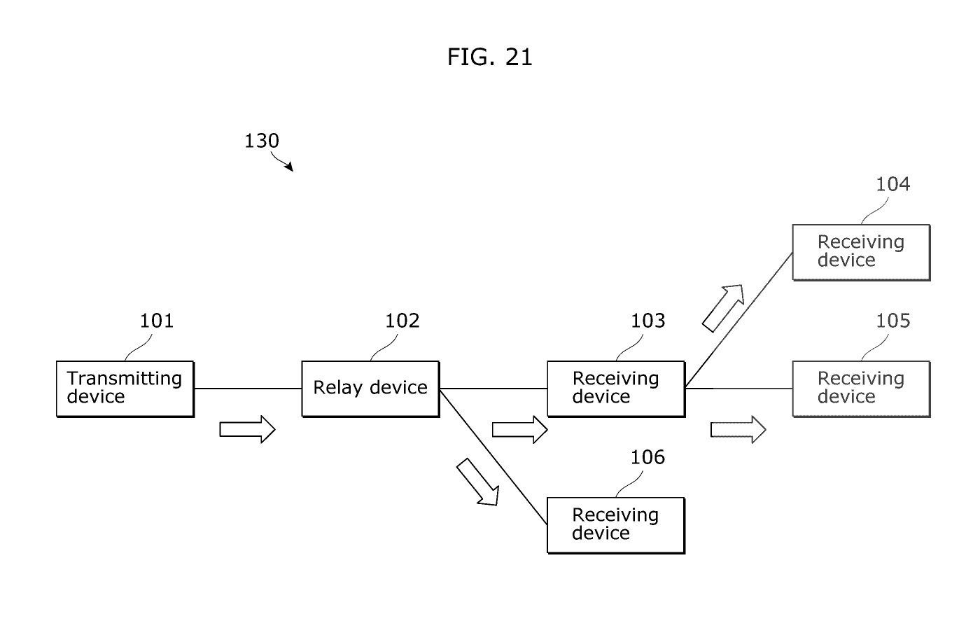

FIG. 21 is a diagram illustrating a modification of an operation after the operation illustrated in FIG. 19, and specifically illustrates a modification of the operation subsequent to the authentication between the relay device 102 and the receiving device 103.

As illustrated in FIG. 21, the configuration of the receiving devices 103 to 106 may differ from the configuration illustrated in FIG. 20. In FIG. 21, the hierarchical depth and the number of the constituent devices including the relay device 102 and the receiving devices 103 to 106 are three and five, respectively. The hierarchical depth and the number of the constituent devices are within respective ranges of the hierarchical depth and the number of devices which are indicated by the device information transmitted to the transmitting device 101 at the time of authentication between the transmitting device 101 and the relay device 102.

Consequently, even when the configuration of FIG. 21 is used, re-authentication is not performed between the transmitting device 101 and the relay device 102. Therefore, the reproducing unit 114 can continue to reproduce data without an interruption even when the receiving devices 103 to 106 are connected to the relay device 102 as illustrated in FIG. 21 during the reproduction of data.

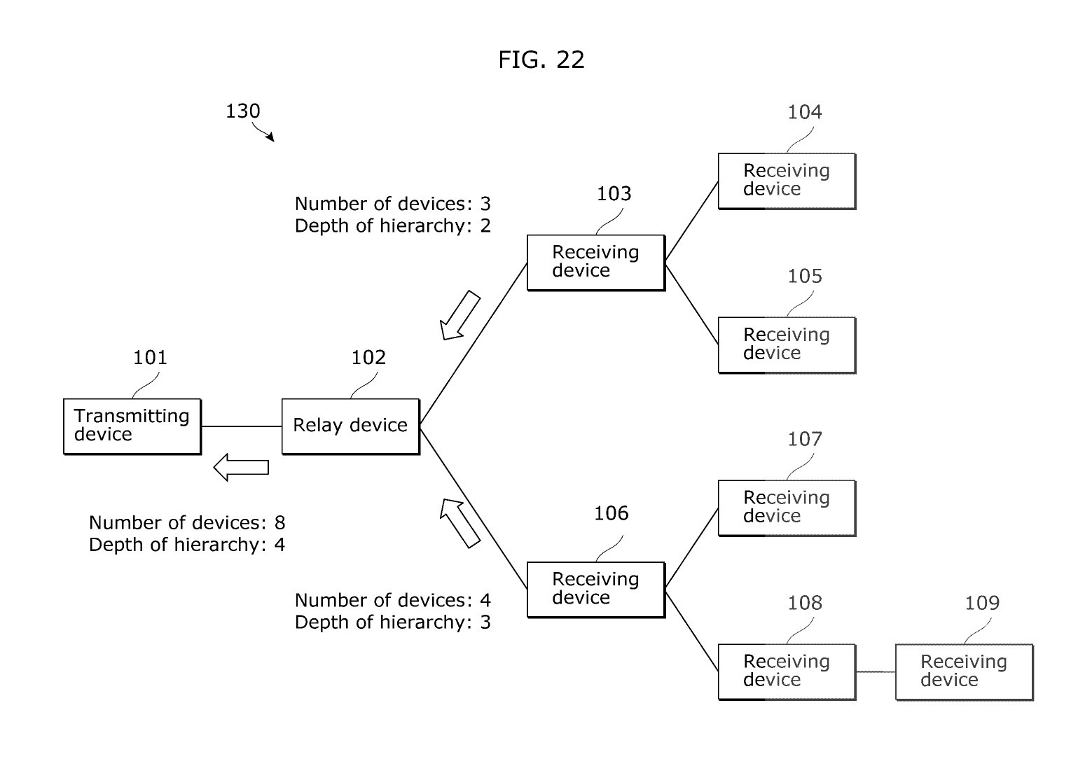

FIG. 22 is a diagram illustrating an operation at the time of authentication in a second aspect of the present embodiment. In the example of FIG. 22, the transmitting and receiving system 130 includes the transmitting device 101, the relay device 102, and the receiving devices 103 to 109. The relay device 102 is connected to the transmitting device 101, and the receiving devices 103 and 106 are connected to the relay device 102. The receiving devices 104 and 105 are connected to the receiving device 103, and the receiving devices 107 and 108 are connected to the receiving device 106. In addition, the receiving device 109 is connected to the receiving device 108.

In the example of FIG. 22, at the time of authentication between the relay device 102 and the receiving device 103, hierarchical information is transmitted to the relay device 102, the hierarchical information indicating that the number of devices is three and the hierarchical depth is two. At the time of authentication between the relay device 102 and the receiving device 106, hierarchical information is transmitted to the relay device 102, the hierarchical information indicating that the number of devices is four and the hierarchical depth is three.

At the time of authentication between the transmitting device 101 and the relay device 102, hierarchical information is transmitted to the transmitting device 101, the hierarchical information indicating that the number of devices is eight and the hierarchical depth is four. That is, the relay device 102 generates the hierarchical information of the constituent devices including the relay device 102 and the receiving devices 103 to 109 by combining the hierarchical information transmitted by the receiving device 103, the hierarchical information transmitted by the receiving device 106, and the information of the relay device 102.

Specifically, the relay device 102 calculates the number of the constituent devices by adding one to the total number of devices indicated by the received hierarchical information. The relay device 102 calculates the hierarchical depth of the constituent devices by adding one to a maximum of the hierarchical depth indicated by the received hierarchical information.

The relay device 102 generates hierarchical information which indicates the calculated number of devices and hierarchical depth, and transmits the generated hierarchical information to the transmitting device 101. In this manner, the relay device 102 can transmit appropriate hierarchical information to the transmitting device 101, even when the receiving devices 103 and 106 are connected to the relay device 102.

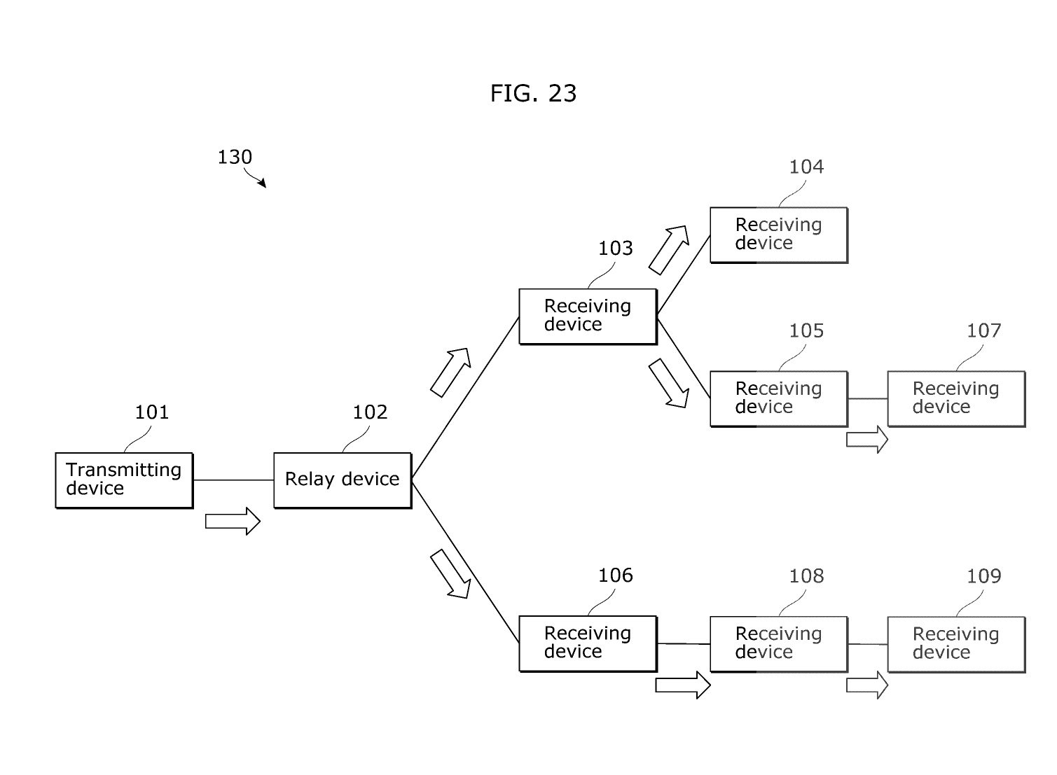

FIG. 23 is a diagram illustrating an operation after the operation illustrated in FIG. 22, and specifically illustrates the operation subsequent to the authentication. The configuration illustrated in FIG. 23 differs from the configuration illustrated in FIG. 22. However, the number and the hierarchical depth of the constituent devices including the relay device 102 and the receiving devices 103 to 109 are within respective ranges of the number of devices and the hierarchical depth which are indicated by the hierarchical information transmitted to the transmitting device 101 in FIG. 22. Therefore, data is transmitted to the receiving devices 103 to 109 without performing re-authentication between the transmitting device 101 and the relay device 102.

[4-3. Effect]

As described above, in the present embodiment, when the communication unit 111 of the relay device 102 transmits device information to the transmitting device 101, the communication unit 111 also transmits hierarchical information of the constituent devices including the relay device 102 and the receiving devices 103 to 106. Thus, the relay device 102 can relay data to the receiving devices 103 to 106 which are hierarchically connected to the relay device 102. In hierarchical connection within a range defined according to the hierarchical information, re-authentication does not occur between the transmitting device 101 and the relay device 102. Consequently, flexible connection is possible.

For example, the communication unit 111 of the relay device 102 may transmit hierarchical information to the transmitting device 101, the hierarchical information indicating the total number and hierarchical depth of the constituent devices. The constituent devices include the relay device 102 and the receiving devices 103 to 106, for example. Thus, the relay device 102 can relay data to the receiving devices 103 to 106 which are hierarchically connected to the relay device 102 in accordance with HDCP.

For example, the communication unit 111 of the relay device 102 may transmit the hierarchical information of constituent devices without using another inter-connection receiving device, the constituent devices including the receiving device 103 connectable to the relay device 102, and the receiving devices 104 to 106 connectable to the relay device 102 via the receiving device 103. Consequently, the relay device 102 can relay data to the receiving devices 104 to 106 via the receiving device 103.

For example, the communication unit 111 of the relay device 102 may receive partial hierarchical information from the receiving device 103 at the time of authentication between the relay device 102 and the receiving device 103. The partial hierarchical information indicates the total number and the hierarchical depth of the receiving devices 103 to 106, for example. In this manner, the relay device 102 can recognize the total number and the hierarchical depth of the receiving devices 103 to 106.

The communication unit 111 may store the received partial hierarchical information in the storage unit 112. At the time of authentication between the transmitting device 101 and the relay device 102, the communication unit 111 may transmit hierarchical information to the transmitting device 101, the hierarchical information being obtained by combining the partial hierarchical information stored in the storage unit 112 with the information on the relay device 102.

In the above step, the communication unit 111 may transmit the hierarchical information to the transmitting device 101 irrespective of a connection state between the relay device 102 and the receiving device 103. That is, after the connection between the relay device 102 and the receiving device 103 is released, the communication unit 111 may transmit the hierarchical information to the transmitting device 101 based on the partial hierarchical information stored in the storage unit 112.

Thus, even when the receiving devices 103 to 106 are hierarchically connected to the relay device 102 after the authentication between the transmitting device 101 and the relay device 102, the relay device 102 can relay data without performing authentication between the transmitting device 101 and the relay device 102.

For example, the communication unit 111 may store hierarchical information in the storage unit 112, the hierarchical information being obtained by combining the received partial hierarchical information with the information of the relay device 102. The communication unit 111 may transmit hierarchical information to the transmitting device 101, the hierarchical information being stored in the storage unit 112. Even with this configuration, the relay device 102 can relay data similarly to the above operation.

For example, instead of the communication unit 111, the control unit 116 may perform part of the operation which is to be performed by the communication unit 111 in the relay device 102. For example, the receiving unit 113 may receive partial hierarchical information from another device. Even with this configuration, the relay device 102 can relay data similarly to the above operation.

For example, the number of devices indicated by the hierarchical information may be indicated by the device information. Specifically, the number of devices indicated by the hierarchical information may be indicated by the total number of ReceiverID or KSV indicated by the device information. That is, part of the hierarchical information and part of the device information may be common therebetween. The device information may include the hierarchical information and the hierarchical information may also include the device information.

The hierarchical information may be treated as accompanying information of the device information in the first to third embodiments in the same manner as the device information in the first to third embodiments is treated. For example, the hierarchical information may be pre-stored in the storage unit 112 when the relay device 102 is manufactured.

When the hierarchical information to be transmitted to the transmitting device 101 does not need to include the information of the relay device 102, the relay device 102 may transmit the hierarchical information of the receiving devices 103 to 106 not including the relay device 102.

### Other Embodiments

As shown above, the first to fourth embodiments have been described as examples of technology disclosed in the present application. However, the technology in the present disclosure is not limited to this, and may be applicable to an embodiment for which modification, replacement, addition, and/or omission is made as needed. It is also possible to create a new embodiment by combining some components described in the first to fourth embodiments.

Thus, other embodiments will be exemplified below.

In the first to fourth embodiments, the communication unit 111 and the HDMI communication unit 301 have been described as examples of communication unit (communicator). It is sufficient for the communication unit to transmit the device information of a receiving device to the transmitting device. Thus, the communication unit is not limited to the communication unit 111 and the HDMI communication unit 301.

In the first to fourth embodiments, the storage unit 112 and the sink information holding unit 303 have been described as examples of storage unit (storage). It is sufficient for the storage unit to store the device information of a receiving device. Thus, the storage unit is not limited to the storage unit 112 and the sink information holding unit 303.

In the first to fourth embodiments, the reproducing unit 114 and the audio and video reproducing unit 305 have been described as examples of reproducing unit (player). It is sufficient for the reproducing unit to reproduce data. Thus, the reproducing unit is not limited to the reproducing unit 114 and the audio and video reproducing unit 305.

In the first to fourth embodiments, the display unit 115 and the display unit 309 have been described as examples of display unit (display). It is sufficient for the display unit to displays a GUI. Thus, the display unit is not limited to the display unit 115 and the display unit 309.

In the first, third, and fourth embodiments, the receiving unit 113 and the sink information receiving unit 510 have been described as examples of receiving unit (receiver). It is sufficient for the receiving unit to receive the device information of a receiving device. Thus, the receiving unit is not limited to the receiving unit 113 and the sink information receiving unit 510.

For example, the communication unit, when transmitting the device information of a receiving device to the transmitting device, may transmit the device information of the relay device along with the device information of the receiving device.

In the first to fourth embodiments, a plurality of receiving devices may be connected to the relay device similarly to the fourth embodiment. The device information of the plurality of receiving devices may be stored in the storage unit of the relay device. For example, the device information for up to a number of receiving devices may be stored, the number being defined as the upper limit of receiving devices. The device information may be automatically stored in the storage unit of the relay device irrespective of an operation when authentication is performed between the relay device and a receiving device.

For example, a process to be performed by a specific component may be performed by another component, the specific component being included in the transmitting device, the relay device, and the receiving devices. The order of performing the processes may be changed, and a plurality of processes may be performed in parallel.

The configuration according to the present disclosure may be achieved not only in the form of a relay device, but also in the form of a relay method including processes performed by a relay device. For example, the method is performed by a computer (more specifically, a processor of a computer). The configuration according to the present disclosure may be achieved in the form of a program which causes a computer to execute the method. In addition, the configuration according to the present disclosure may be achieved in the form of a non-transitory computer-readable recording medium such as a CD-ROM on which a program is recorded.

The relay device may be an electronic circuit such as an integrated circuit. The plurality of components included in the relay device may be a single circuit as a whole or separate circuits. These components each may be a general-purpose circuit or a dedicated circuit.

The relay device may include a memory and a processor corresponding to the components shown in the first to fourth embodiments. The processor may perform with the memory the process shown in the first to fourth embodiments.

As shown above, the embodiments have been described as examples of technology in the present disclosure. For this purpose, the accompanying drawings and detailed description have been provided.

Consequently, in order to exemplify the technology, the components illustrated in the accompanying drawings and detailed description may include not only the components necessary for problem solving, but also the components unnecessary for problem solving. For this reason, it is to be understood that those unnecessary components should not be recognized as necessary components just because the unnecessary components are described in the accompanying drawings and detailed description.

Because the above-described embodiments are provided for the purpose of exemplifying the technology in the present disclosure, various modifications, replacements, additions, and omissions may be made in the scope of claims and equivalent thereof.

### INDUSTRIAL APPLICABILITY

The present disclosure is applicable to a relay device which relays data from a transmitting device to a receiving device. Specifically, the present disclosure is applicable to a television receiver, a video reproducing device, and an audio reproducing device.

1. A relay device which relays data, the relay device comprising:
a storage unit configured to store device information of at least one receiving device which is connectable to the relay device; and
a communication unit configured to transmit the device information to a transmitting device when authentication is performed between the transmitting device and the relay device, the device information being pre-stored in the storage unit before the authentication is performed.

2. The relay device according to claim 1,
wherein the communication unit is configured to transmit the device information to the transmitting device even when connection is not established between the relay device and the at least one receiving device.

3. The relay device according to claim 1,
wherein the communication unit is configured to transmit the device information to the transmitting device when the device information is stored in the storage unit.

4. The relay device according to claim 1, further comprising
a display unit configured to display a graphical user interface (GUI) for storing the device information in the storage unit.

5. The relay device according to claim 1,
wherein when the relay device is manufactured, the device information is stored in the storage unit.

6. The relay device according to claim 1, further comprising
a receiving unit configured to receive the device information from a device other than the at least one receiving device,
wherein the storage unit is configured to store the device information received by the receiving unit before the authentication is performed.

7. The relay device according to claim 1,
wherein the communication unit is configured to transmit the device information for uniquely identifying the at least one receiving device to the transmitting device.

8. The relay device according to claim 7,
wherein the device information is a ReceiverID or a KSV which is information for uniquely identifying the at least one receiving device in accordance with high-bandwidth digital content protection (HDCP) which is a scheme for protecting the data, and
the communication unit is configured to transmit the device information to the transmitting device when the authentication is performed between the transmitting device and the relay device in accordance with the HDCP, the device information being pre-stored in the storage unit before the authentication is performed in accordance with the HDCP.

9. The relay device according to claim 1, further comprising
a reproducing unit configured to reproduce the data received from the transmitting device after the authentication is performed,
wherein the reproducing unit is configured to continue reproducing the data without interruption even when relaying of the data to the at least one receiving device starts in a middle of the reproducing of the data.

10. The relay device according to claim 1,
wherein the communication unit is configured to transmit the device information to the transmitting device when the authentication is performed and to receive the data which is allowed to be transmitted to the at least one receiving device even when the data is not scheduled to be transmitted to the at least one receiving device at a time of the authentication.

11. The relay device according to claim 1,
wherein the communication unit is configured to further transmit hierarchical information of a plurality of constituent devices to the transmitting device when transmitting the device information to the transmitting device, the constituent devices including the relay device and the at least one receiving device.

12. The relay device according to claim 11,
wherein the communication unit is configured to transmit the hierarchical information to the transmitting device, the hierarchical information indicating a total number of the constituent devices and a depth of hierarchy of the constituent devices.

13. The relay device according to claim 12,
wherein the communication unit is configured to transmit the hierarchy information to the transmitting device, the hierarchy information indicating the total number and the depth of hierarchy of the constituent devices including the relay device, a first receiving device connectable to the relay device without using another receiving device for inter-connection, and a second receiving device connectable to the relay device via the first receiving device.

14. The relay device according to claim 13,
wherein the communication unit is configured to receive partial hierarchical information from the first receiving device when authentication is performed between the relay device and the first receiving device, the partial hierarchical information indicating a total number of receiving devices including the first receiving device and the second receiving device, and a depth of hierarchy of the receiving devices,
the storage unit is configured to store the partial hierarchical information received by the communication unit, and
the communication unit is configured to transmit the hierarchical information to the transmitting device when authentication is performed between the transmitting device and the relay device after release of connection between the relay device and the first receiving device, the hierarchical information being obtained by combining the partial hierarchical information stored in the storage unit with information of the relay device.

15. The relay device according to claim 13,
wherein the communication unit is configured to receive partial hierarchical information from the first receiving device when authentication is performed between the relay device and the first receiving device, the partial hierarchical information indicating a total number of receiving devices including the first receiving device and the second receiving device, and a depth of hierarchy of the receiving devices,
the storage unit is configured to store the hierarchical information which is obtained by combining the partial hierarchical information received by the communication unit with information of the relay device, and
the communication unit is configured to transmit the hierarchical information stored in the storage unit to the transmitting device when authentication is performed between the transmitting device and the relay device after release of connection between the relay device and the first receiving device.

16. A method of relaying data, the method comprising:
transmitting a device information to a transmitting device when authentication is performed between the transmitting device and a relay device, the device information being of at least one receiving device connectable to the relay device and being pre-stored in a storage unit before the authentication is performed.
